(19) United States
(12) Patent Application Publication
(10) Pub. No.: US 2009/0248458 A1
(43) Pub. Date: Oct. 1, 2009

(54) Method And System To Enable A User Of A Mobile Communication Device To Use A Flight Pass

(75) Inventors: Patrice Ouellette, Lachine (CA); Louise Lanoix, Brossard (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Air Canda, Dorval (CA)

(21) Appl. No.: 12/237,308

(22) Filed: Sep. 24, 2008

Related U.S. Application Data
(60) Provisional application No. 61/040,427, filed on Mar. 28, 2008.

(51) Int. Cl. G06Q 10/00; G06Q 50/00; G06Q 20/00; G06F 15/16

(52) U.S. Cl. 705/5; 715/825; 709/206; 705/30; 705/40

(57) ABSTRACT

A method for enabling a user of a mobile communication device to use a flight pass that is associated with a bank of air travel credit applicable to book flights. The method comprises: transmitting data conveying information regarding the flight pass to be presented to the user via a graphical user interface of the mobile communication device; receiving data conveying a request to book a flight using the flight pass made by the user via the graphical user interface of the mobile communication device; and causing a booking of the flight using the flight pass. A system for implementing the method is also disclosed.

### CROSS-REFERENCE TO RELATED APPLICATION

This application claims the benefit under 35 U.S.C. §119(e) of U.S. Provisional Patent Application No. 61/040,427 filed on Mar. 28, 2008 and hereby incorporated by reference herein.

### FIELD OF THE INVENTION

The invention relates generally to air travel services and, more particularly, to a method and a system to enable a user of a mobile communication device to use a flight pass.

### BACKGROUND

Certain types of travelers (e.g., some business travelers) expect to travel by air with some frequency but cannot predict exactly when such travel will occur. For such travelers, a “flight pass”, which is a commercial product (such as is available from Air Canada™) associated with a bank of air travel credit applicable to book flights (and possibly obtain other air travel services) in accordance with certain air travel conditions (e.g., geographic and/or temporal constraints), can be convenient.

While certainly useful, in certain cases, some business or other travelers may need to book flights on the go and/or on short notice using their flight passes. Accordingly, there is a need for solutions that enable more convenient access to and use of flight passes.

### SUMMARY OF THE INVENTION

According to a first broad aspect, the invention provides a method for enabling a user of a mobile communication device to use a flight pass that is associated with a bank of air travel credit applicable to book flights. The method comprises: transmitting data conveying information regarding the flight pass to be presented to the user via a graphical user interface of the mobile communication device; receiving data conveying a request to book a flight using the flight pass made by the user via the graphical user interface of the mobile communication device; and causing a booking of the flight using the flight pass.

According to a second broad aspect, the invention provides a system for enabling a user of a mobile communication device to use a flight pass that is associated with a bank of air travel credit applicable to book flights. The system comprises a communication entity configured for: transmitting data conveying information regarding the flight pass to be presented to the user via a graphical user interface of the mobile communication device; and receiving data conveying a request to book a flight using the flight pass made by the user via the graphical user interface of the mobile communication device. The system also comprises a processing entity configured for causing a booking of the flight using the flight pass.

According to a third broad aspect, the invention provides computer-readable media containing program code executable by a computing system to implement a process for enabling a user of a mobile communication device to use a flight pass that is associated with a bank of air travel credit applicable to book flights. The program code comprises: first program code for causing the computing system to transmit data conveying information regarding the flight pass to be presented to the user via a graphical user interface of the mobile communication device; second program code for causing the computing system to receive data conveying a request to book a flight using the flight pass made by the user via the graphical user interface of the mobile communication device; and third program code for causing the computing system to cause a booking of the flight using the flight pass.

According to a fourth broad aspect, the invention provides a method for execution by a user of a mobile communication device. The method comprises: obtaining information regarding a flight pass via a graphical user interface of the mobile communication device; and making a request to book a flight using the flight pass via the graphical user interface of the mobile communication device.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an air travel service system for providing a mobile flight pass service to a user of a mobile communication device, in accordance with an embodiment of the invention;

FIG. 2 shows an example of contents of a database of the air travel service system that stores information regarding a plurality of flight passes, in accordance with an embodiment of the invention; and

FIGS. 3 to 27 show examples of pages displayed on a graphical user interface of the mobile communication device when the user uses the mobile communication device to access a site implemented by the air travel service system, including a sequence of pages allowing the user to obtain information regarding a flight pass and make a request to book a flight using the flight pass, in accordance with an embodiment of the invention.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

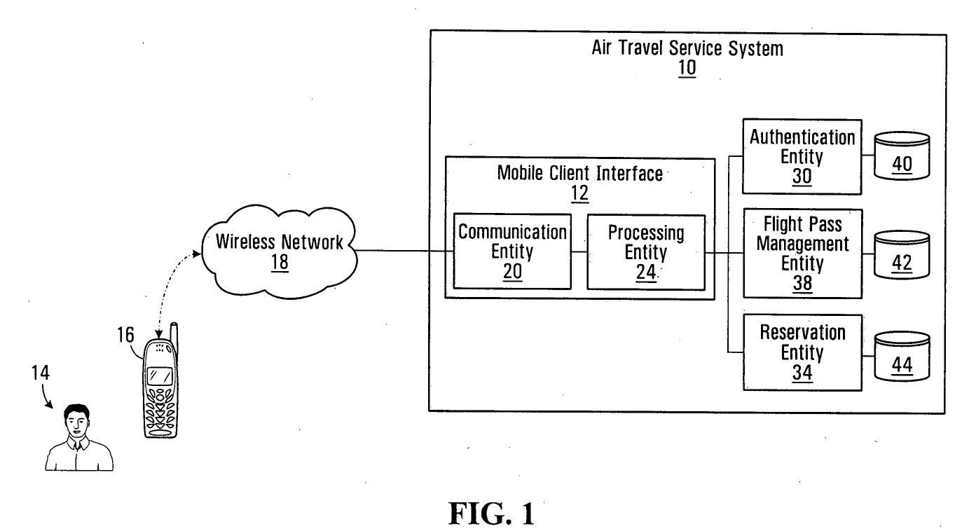

FIG. 1 shows an air travel service system 10 for facilitating provision of air travel services (e.g., flights) to various users in accordance with an embodiment of the invention. These air travel services are provided by an air travel service provider (e.g., an airline company) or group of air travel service providers (e.g., Star Alliance™) associated with the air travel service system 10.

The air travel service system 10 comprises a mobile client interface 12 allowing users of mobile communication devices, such as a user 14 of a mobile communication device 16, to access and interact with the air travel service system 10 via a wireless network 18, which can be a cellular network or another wireless network covering a large geographical area of several hundred square kilometers or more (e.g., a WiMAX network). More particularly, the mobile client interface 12 comprises a communication entity 20 implementing a site accessible by the mobile communication device 16 via the wireless network 18 in order to allow the user 14 to obtain information and make requests in connection with air travel services. To that end, the communication entity 20 comprises suitable hardware, software and/or control logic for exchanging data with the mobile communication device 16 via the wireless network 18. For example, the communication entity 20 may comprise a server (e.g., a mobile web server) configured to deliver pages for presentation by the mobile communication device 16 (e.g., pages written in Extensible Hypertext Markup Language (XHTML) or Wireless Markup Language (WML)).

The mobile communication device 16 is configured for mobile voice and data communication over the wireless network 18. For example, the mobile communication device 16 may be a smartphone (e.g., BlackBerry™, Treo™, etc.) or other cellular phone with data communication capability To enable the user 14 to interact therewith, the mobile communication device 16 comprises a set of input devices, including a microphone to capture speech of the user 14 and one or more manual input devices to receive information manually input by the user 14, such as a keyboard or other arrangement of keys, a pointing device and/or a touchscreen. The mobile communication device 16 also comprises a set of output devices, including a speaker to emit sound (e.g., speech) to be heard by the user 14 and a display to visually present information to the user 14.

As part of its data communication capability, the mobile communication device 16 is configured to execute a client software application that interacts with the communication entity 20 of the air travel service system 10 and with the user 14 in order to allow him/her to obtain information and make requests in connection with air travel services. For example, the client software application executed by the mobile communication device 16 may be a mobile browser (i.e., a web browser designed to enable a mobile phone or other mobile communication device to access web sites—sometimes also referred to as a microbrowser or minibrowser) or a customized program designed specifically to communicate with the communication entity 20. More particularly, the client software application executed by the mobile communication device 16 interacts with the communication entity 20 of the air travel service system 10 to cause the mobile communication device 16 to implement a graphical user interface (GUI) for interacting with the user 12. The communication entity 20 cooperates with the client software application executed by the mobile communication device 16 in order to allow information from the air travel service system 10 to be conveyed to the user 14 via the GUI of the mobile communication device 16 and to allow the user 14 to convey information to the air travel service system 10 via the GUI of the mobile communication device 16.

The air travel service system 10 provides various “mobile air travel services” to the user 14 when he/she uses the mobile communication device 16 to access the site implemented by the communication entity 20.

In particular, according to an embodiment of the invention, one mobile air travel service that is provided to the user 14 is a “mobile flight pass service” that enables the user 14 to use a “flight pass” by accessing the site implemented by the communication entity 20 using the mobile communication device 16. A flight pass is a commercial product that is associated with a bank of air travel credit applicable to book flights (and possibly obtain other air travel services) offered by the air travel service provider or group of air travel service providers associated with the air travel service system 10, in accordance with air travel conditions. The air travel credit associated with the flight pass may take on various forms. For example, in some embodiments, one (1) credit may be applicable to book one (1) one-way trip including any connecting flight. The air travel conditions associated with the flight pass can also take on various forms. For instance, the air travel conditions associated with the flight pass may specify geographic and/or temporal constraints regarding flights towards which the air travel credit is applicable. Examples of geographic constraints include groups of origins and destinations for flights towards which the air travel credit is applicable, such as groups of origin and destination airport codes. Examples of temporal constraints include a period of validity during which all air travel credit needs to be expended. It will be appreciated that, in other embodiments, the air travel credit and the air travel conditions associated with the flight pass make take on many other forms.

As will be further discussed below, the mobile flight pass service allows the user 14 to obtain various information regarding a flight pass and make a request involving the flight pass, such as a request to book a flight using the flight pass, by using the mobile communication device 16 to access the site implemented by the communication entity 20. Other mobile air travel services that may be provided to the user 14 include: a “mobile check-in service” that enables the user 14 to check-in for a booked flight by accessing the site implemented by the communication entity 20 using the mobile communication device 16; a “mobile flight notification service” that enables the user 14 to request to receive notification (e.g., via a short message service (SMS) message or an email message) on the mobile communication device 16 or another communication device if a departure time and/or an arrival time of a booked flight is delayed or changed, by accessing the site implemented by the communication entity 20 using the mobile communication device 16; a “mobile flight status service” that enables the user 14 to access real-time departure and arrival information for flights offered by the air travel service provider or group of air travel service providers associated with the air travel service system 10, by accessing the site implemented by the communication entity 20 using the mobile communication device 16; a “mobile flight timetable service” that enables the user 14 to flight schedules for flights offered by the air travel service provider or group of air travel service providers associated with the air travel service system 10, by accessing the site implemented by the communication entity 20 using the mobile communication device 16; and possibly other services.

In order to provide the mobile air travel services offered via the site implemented by the communication entity 20, the mobile client interface 12 comprises a processing entity 24 in communication with other functional entities of the air travel service system 10, including, in this embodiment, an authentication entity 30, a flight pass management entity 38 and a reservation entity 34 that are utilized for provision of the mobile flight pass service contemplated herein. To that end, the processing entity 24 comprises suitable hardware, software and/or control logic to exchange data with the authentication entity 30, the flight pass management entity 38 and the reservation entity 34. The processing entity 24 may also be in communication with other functional entities (not shown) for provision of other ones of the mobile air travel services that may be offered via the site implemented by the communication entity 20.

In some embodiments, the communication entity 20 and the processing entity 24 may be implemented by a single computing apparatus (e.g., a single server). In other embodiments, the communication entity 20 and the processing entity 24 may be implemented by a plurality of computing apparatuses (e.g., a plurality of servers) that are interconnected by one or more communication links. For example, in some embodiments, the communication entity 20 may be implemented by a server operated by a wireless network provider managing the wireless network 18 and the processing entity 24 may be implemented by a server operated by the air travel service provider or group of air travel service providers associated with the air travel service system 10, these two servers being interconnected by a communication link established over a public data network such as the Internet and a private data network (e.g., a virtual private network (VPN)) at each end.

The authentication entity 30 is configured to authenticate users of mobile communication devices (such as the user 14 of the mobile communication device 16) who make certain requests when accessing the site implemented by the communication entity 20. To that end, the authentication entity 30 has access to (i.e., comprises or is linked to) a database 40 that stores identification information (e.g., names, loyalty marketing program identifiers such as an Aeroplan™ numbers, or other identifiers) specifying identities of various pre-registered users as well as associated authentication information specifying authentication credentials (e.g., passwords) and permissions for these pre-registered users. The permissions associated with a given pre-registered user pertain to activities that he/she is (or is not) allowed to perform when accessing the site implemented by the communication entity 20. For example, the permissions may specify what functions or actions the given pre-registered user can use or request and what information the given pre-registered user is allowed to access.

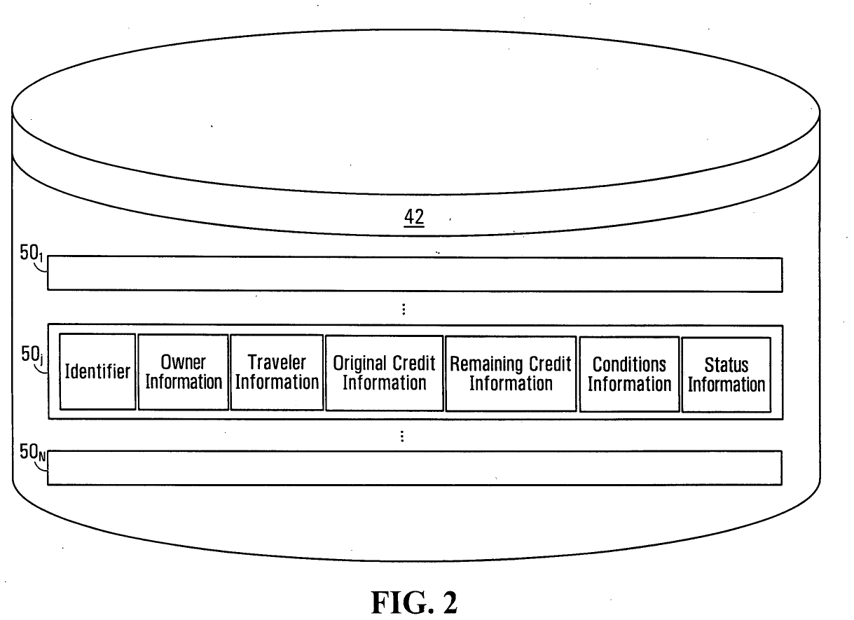

The flight pass management entity 38 is configured to manage utilization of flight passes by users of mobile communication devices (such as the user 14 of the mobile communication device 16). To that end, the flight pass management entity 38 has access to (i.e., comprises or is linked to) a database 42 that stores information regarding a plurality of flight passes. FIG. 2 shows an example of potential contents of the database 42. In this example, the database 42 contains a plurality of records (or other data structures) 50₁ . . . 50_{N}, where each one of these records includes information regarding a respective one of the flight passes, such as one or more of:
an identifier (e.g., a name, an identification code) of the respective one of the flight passes;
owner information identifying an owner of the respective one of the flight passes. For example, this may include a name of the owner, a loyalty marketing program identifier such as an Aeroplan™ number of the owner, or some other identifier of the owner;
traveler information identifying one or more travelers associated with the respective one of the flight passes (i.e., one or more individuals allowed to travel on flights booked using the respective one of the flight passes). For example, this may include a name of each traveler, a loyalty marketing program identifier such as an Aeroplan™ number of each traveler, or some other identifier of each traveler;
original credit information indicative of an original amount of air travel credit in the bank of air travel credit associated with the respective one of the flight passes. The original amount of air travel credit can be measured in a variety of ways such as units, flights, miles, dollars, etc.;
remaining credit information indicative of a remaining amount of air travel credit in the bank of air travel credit associated with the respective one of the flight passes. The remaining amount of air travel credit fluctuates over time, and is reduced as flights are booked using the respective one of the flight passes and can be increased, for instance, when new air travel credit is purchased and added to the bank of air travel credit or when a flight previously booked using the respective one of the flight passes is cancelled;
conditions information specifying air travel conditions associated with the respective one of the flight passes, which, as stated earlier, may include geographical and/or temporal constraints regarding flights towards which is applicable the air travel credit in the bank of air travel credit associated with the respective one of the flight passes; and
status information indicative of a status (such as “active”, “hold”, “expired”, “inactive”, etc.) of the respective one of the flight passes.

Various other information regarding a given flight pass may be included in a particular one of the records 50₁ . . . 50_{N} that is associated with the given flight pass in the database 42.

The reservation entity 34 is configured to verify flight availability, make bookings, change bookings and cancel bookings, including selecting, changing and canceling various flight attributes such as seats, meals, etc. To that end, the reservation entity 34 has access to (i.e., comprises or is linked to) a database 44 storing availability and booking information regarding various flights. For example, the reservation entity 34 and the database 44 may be implemented by an existing reservation system used by the air travel service provider or group of air travel service provides associated with the air travel service system 10.

Each of the authentication entity 30, the flight pass management entity 38 and the reservation entity 34 comprises suitable hardware, software and/or control logic to implement its functionality. In some embodiments, the authentication entity 30, the flight pass management entity 38 and the reservation entity 34 may be implemented by a single computing apparatus (e.g., a single server), while in other embodiments they may be implemented by a plurality of computing apparatuses (e.g., a plurality of servers) that are interconnected by one or more communication links.

An example of a process by which the user 14 may use the mobile communication device 16 in connection with the mobile flight pass service contemplated herein will now be described. In this example, the user 14 uses the mobile communication device 16 to access the site implemented by the communication entity 20 of the air travel service system 10. For instance, this can be achieved by entering a hostname (such as “mobile.aircanada.com”), address or other identifier of the communication entity 20 on the mobile communication device 16. The client software application implemented by the mobile communication device 16 then establishes communication with the communication entity 20 over the wireless network 18 and subsequently exchanges data with the communication entity 20 to allow information from the air travel service system 10 to be presented to the user 14 via the GUI of the mobile communication device 16 and to allow the user 14 to provide information to the air travel services system 10 via the GUI of the mobile communication device 16.

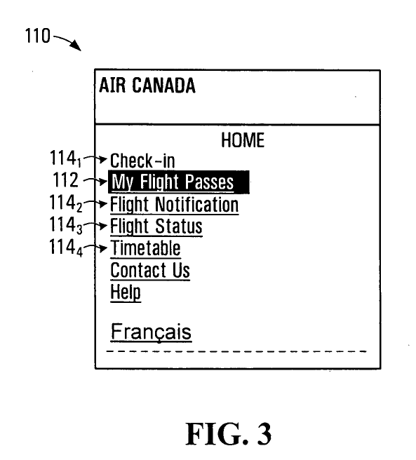

More particularly, and with additional reference to FIG. 3, upon being accessed by the mobile communication device 16, the communication entity 20 transmits data to cause the GUI of the mobile communication device 16 to display a menu page 110. The menu page 110 includes a set of option elements defining a menu of options that can be selected by the user 14 and that correspond to different ones of the mobile air travel services offered via the site implemented by the communication entity 20, including an option element 112 corresponding to the mobile flight pass service contemplated herein as well as option elements 114₁ . . . 114₄ corresponding to the aforementioned mobile check-in service, mobile flight notification service, mobile flight status service, and mobile flight timetable service.

For purposes of this example, it is assumed that the user 14 interacts with the mobile communication device 16 to select the option element 112 corresponding to the mobile flight pass service contemplated herein. This selection of the option element 112 causes the mobile communication device 16 to transmit data indicating to the communication entity 20 that the user 14 desires to avail himself/herself of the mobile flight pass service.

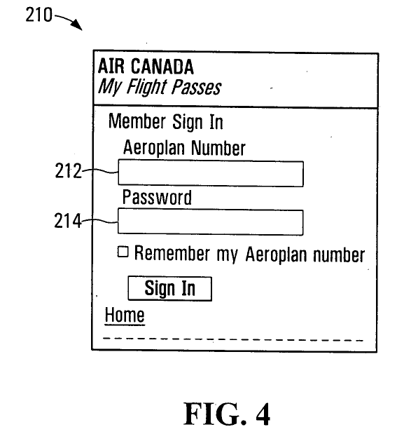

As shown in FIG. 4, upon determining that the user 14 has selected the mobile flight pass service, the communication entity 20 transmits data to cause the GUI of the mobile communication device 16 to display a login page 210. The login page 210 includes an identification information input element 212 and an authentication information input element 214. The identification information input element 212 allows the user 14 to provide identification information that identifies an owner or authorized user of a flight pass. In this embodiment, the identification information to be input via the identification information input element 212 is a loyalty marketing program identifier, in this case, an Aeroplan™ number, whereas in other embodiments it may be a name, a username, or any other information identifying an owner or authorized user of a flight pass. The authentication information input element 214 allows the user 14 to provide authentication information that can be validated to authenticate a user claiming to be an owner or authorized user of a flight pass. In this embodiment, the authentication information to be input via the authentication information input element 214 is a password, whereas in other embodiments it may be various other information (e.g., a date of birth or some other item of information expected to be known to a legitimate user but not to an illegitimate one, or biometric information such as a voiceprint).

The user 14 proceeds to interact with the mobile communication device 16 to provide identification information, in this case, a particular Aeroplan™ number, and authentication information, in this case, a particular password, via the identification information input element 212 and the authentication information input element 214. Upon the user 14 selecting a “sign in” button on the login page 210, the mobile communication device 16 transmits data conveying the particular Aeroplan™ number and the particular password provided by the user 14 to the communication entity 20.

Upon reception at the communication entity 20 of the data conveying the particular Aeroplan™ number and the particular password provided by the user 14, the processing entity 24 proceeds to interact with the authentication entity 30 based on this data in order to determine whether the user 14 is to be granted access to one or more flight passes that may be associated with the particular Aeroplan™ number provided by the user 14. More particularly, the authentication entity 30 searches the database 40 for any identification information, in this case, any Aeroplan™ number corresponding to the particular Aeroplan™ number provided by the user 14. If the authentication entity 30 does not find any Aeroplan™ number corresponding to the particular Aeroplan™ number provided by the user 14, the processing entity 24 causes the communication entity 20 to transmit data 30 for causing the GUI of the mobile communication device 16 to display an error page (not shown) informing the user 14 that the particular Aeroplan™ number is not valid.

For purposes of this example, it is assumed that the authentication entity 30 finds in the database 40 an Aeroplan™ number corresponding to the particular Aeroplan™ number provided by the user 14. The authentication entity 30 proceeds to compare authentication information, in this case, a password, stored in the database 40 in association with the particular Aeroplan™ number to the particular password provided by the user 14. If the password stored in the database 40 in association with the particular Aeroplan™ number does not correspond to the particular password provided by the user 14, the processing entity 24 causes the communication entity 20 to transmit data for causing the GUI of the mobile communication device 16 to display an error page (not shown) informing the user 14 that the particular password provided is not valid for the particular Aeroplan™ number provided.

Assuming that, in this example, the password stored in the database 40 in association with the particular Aeroplan™ number corresponds to the particular password provided by the user 14, the authentication entity 30 notifies the processing entity 24 that the particular password has been validated. Upon determining that the particular password provided by the user 14 has been validated, the processing entity 24 interacts with the flight pass management entity 38 to seek information regarding one or more flight passes that may be associated with the identification information, in this case, the particular Aeroplan™ number, provided by the user 14.

The flight pass management entity 38 consults the database 42 based on the particular Aeroplan™ number provided by the user 14 in an attempt to find one or more of the records 50₁ . . . 50_{N} whose owner information and/or traveler information includes an Aeroplan™ number corresponding to the particular Aeroplan™ number provided by the user 14. If it does not find any of the records 50₁ . . . 50_{N} whose owner information and/or traveler information includes an Aeroplan™ number corresponding to the particular Aeroplan™ number provided by the user 14 (or if it does find one or more such records but determines from the status information contained therein that the one or more flight passes associated therewith is/are not active), the flight pass management entity 38 notifies the processing entity 24 which proceeds to cause the communication entity 20 to transmit data for causing the GUI of the mobile communication device 16 to display a page (not shown) informing the user 14 that no active flight pass has been found.

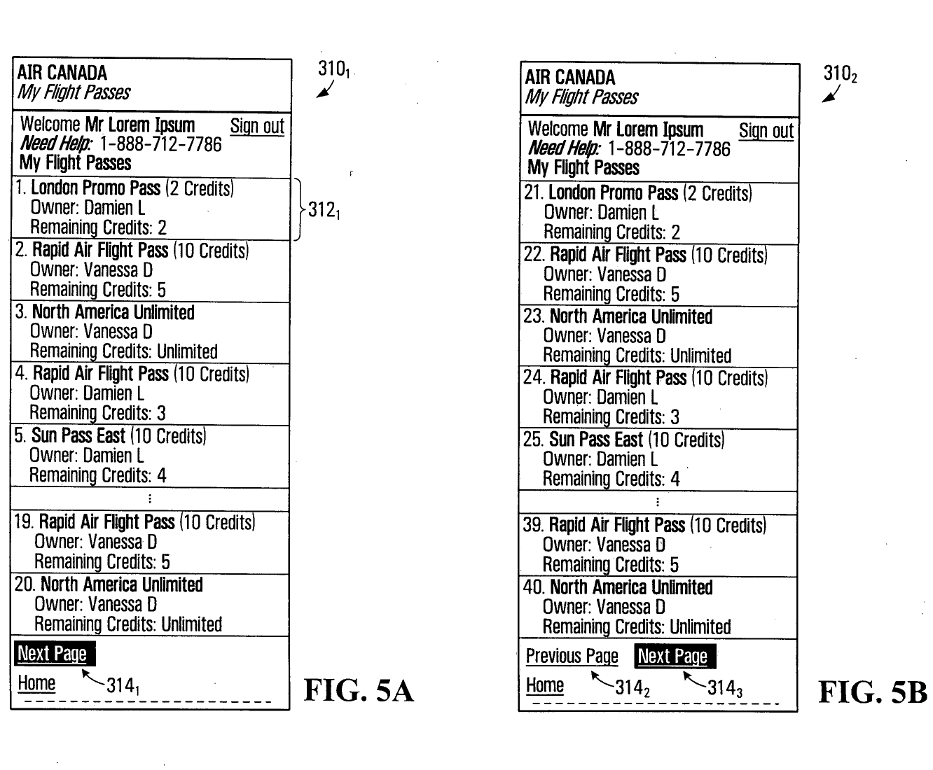

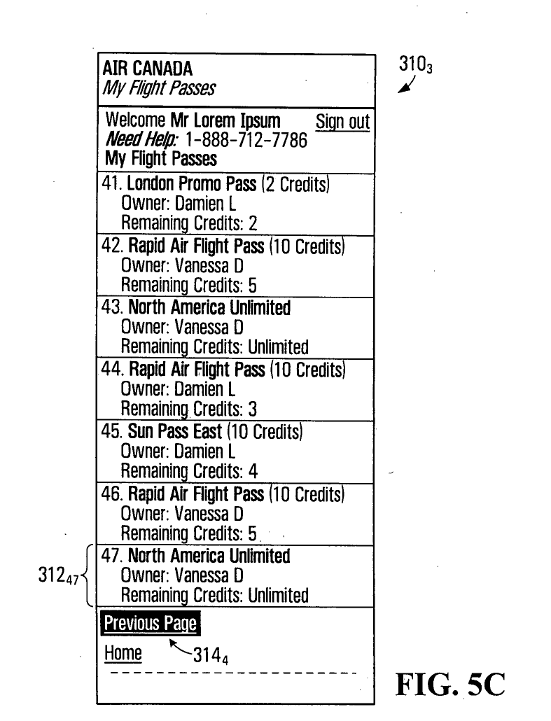

In this example, it is assumed that the flight pass management entity 38 finds plural ones of the records 50₁ . . . 50_{N} whose owner information and/or traveler information includes an Aeroplan™ number corresponding to the particular Aeroplan™ number provided by the user 14. As shown in FIG. 5, the processing entity 24 proceeds to interact with the flight pass management entity 38 in order to cause the communication entity 20 to transmit data for causing the GUI of the mobile communication device 16 to display a series of flight pass list pages 310₁ . . . 310₃ that convey a list of flight passes (containing, in this case, forty-seven (47) flight passes) associated with the plural ones of the records 50₁ . . . 50_{N} whose owner information and/or traveler information includes an Aeroplan™ number corresponding to the particular Aeroplan™ number provided by the user 14. More particularly, the flight pass list pages 310₁ . . . 310₃ include a plurality of areas 312₁ . . . 312₄₇, where each area 312ᵢ conveys information regarding a given flight pass of the list of flight passes that has been obtained from the database 42. For example, in this embodiment, the information regarding the given flight pass includes: an identifier of the given flight pass, in this case a name of the given flight pass; owner information identifying an owner of the given flight pass, in this case a name of the owner; original credit information (in brackets) indicative of an original amount of air travel credit in the bank of air travel credit associated with the given flight pass; and remaining credit information indicative of a remaining amount of air travel credit in the bank of air travel credit associated with the given flight pass. By interacting with the mobile communication device 16, the user 14 can scroll up and down each of the flight pass list pages 310₁ . . . 310₃ to view different flight passes of the list of flight passes. Each of the flight pass list pages 310₁ . . . 310₃ includes one or more navigation elements 314₁ . . . 314₄ allowing the user 14 to move from one page to another.

The user 14 can interact with the mobile communication device 16 to select a given flight pass of the list of flight passes in order to obtain additional information regarding the given flight pass and/or make a request involving the given flight pass, such as a request to book a flight using the given flight pass. For purposes of this example, it is assumed that the user 14 interacts with the mobile communication device 16 to select the flight pass named “Rapid Air Flight Pass” which is associated with the area 312₄ of the flight pass list page 310₁ and which will hereinafter be referred to as the “RAFP flight pass”. In response to the user 14 selecting the RAFP flight pass through interaction therewith (e.g., by pressing on one or more keys thereof), the mobile communication device 16 transmits data indicative that the user 14 selected the RAFP flight pass to the communication entity 20.

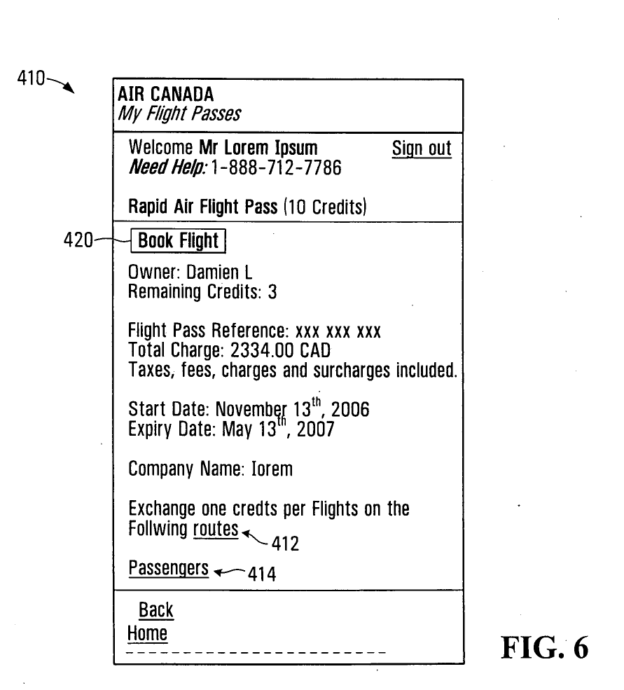

As shown in FIG. 6, upon reception of the data indicative that the user 14 selected the RAFP flight pass at the communication entity 20, the processing entity 24 proceeds to interact with the flight pass management entity 38 in order to cause the communication entity 20 to transmit data for causing the GUI of the mobile communication device 16 to display a flight pass information page 410 conveying information regarding the RAFP flight pass that has been obtained from the database 42. For example, in this embodiment, the information regarding the RAFP flight pass includes: an identifier of the RAFP flight pass, in this case the name “Rapid Air Flight Pass”; owner information identifying an owner of the RAFP flight pass, in this case the name “Damien L”; original credit information (in brackets) indicative of an original amount of air travel credit in the bank of air travel credit associated with the RAFP flight pass, in this case 10 credits; remaining credit information indicative of a remaining amount of air travel credit in the bank of air travel credit associated with the RAFP flight pass, in this case 3 credits; a price of the RAFP flight pass, in this case 2,334 $ CAD; and a start date and an expiry date of the RAFP flight pass, in this case Nov. 13, 2006 and May 13, 2007, respectively, defining a period of time during which the RAFP flight pass can be used.

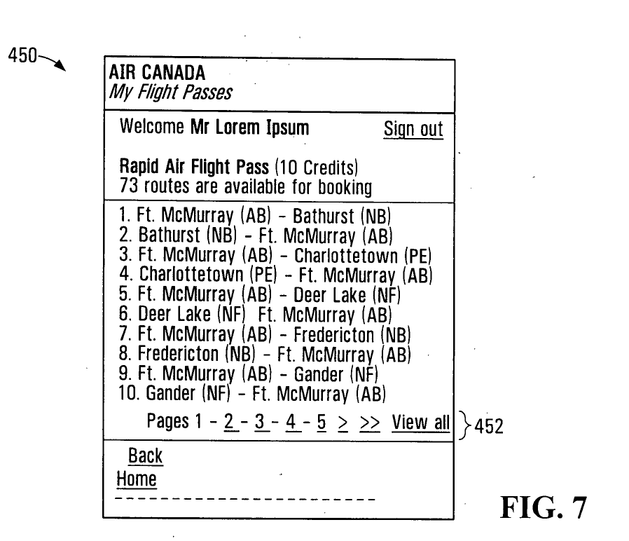

The flight pass information page 410 also includes a route information element 412 allowing the user 14 to obtain route information regarding routes available for booking flights using the RAFP flight pass. More particularly, when the user 14 interacts with the mobile communication device 16 so as to act on the route information element 412, the mobile communication device 16 transmits data indicative that the user 14 selected the route information element 412 to the communication entity 20. As shown in FIG. 7, upon reception of the data indicative that the user 14 selected the route information element 412 at the communication entity 20, the processing entity 24 proceeds to interact with the flight pass management entity 38 in order to cause the communication entity 20 to transmit data for causing the GUI of the mobile communication device 16 to display one or more routes pages, in this case, five (5) routes pages including a route page 450, conveying route information regarding routes available for booking flights using the RAFP flight pass that has been obtained from the database 42. In this example, the route information specifies pairs of origin and destination cities for flights that can be booked using the RAFP flight pass. The route page 450 includes a navigation element 452 allowing the user 14 to view other ones of the route pages or all of the pairs of origin and destination cities on one route page.

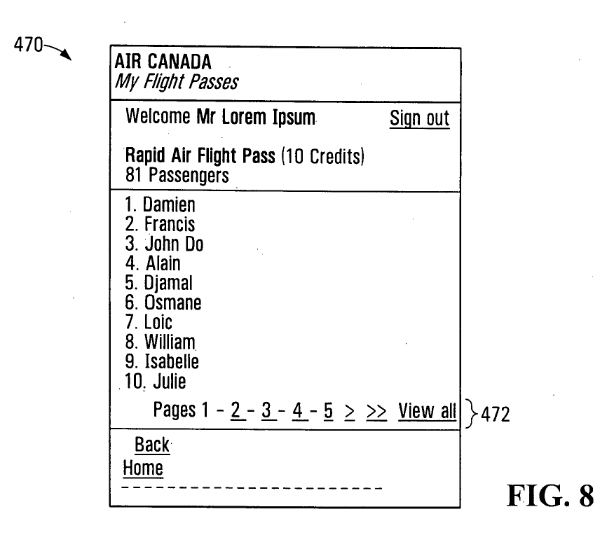

The flight pass information page 410 also includes a traveler information element 414 allowing the user 14 to obtain traveler information identifying one or more individuals allowed to travel on flights booked using the RAFP flight pass. More particularly, when the user 14 interacts with the mobile communication device 16 so as to act on the traveler information element 414, the mobile communication device 16 transmits data indicative that the user 14 selected the traveler information element 414 to the communication entity 20. As shown in FIG. 8, upon reception of the data indicative that the user 14 selected the traveler information element 414 at the communication entity 20, the processing entity 24 proceeds to interact with the flight pass management entity 38 in order to cause the communication entity 20 to transmit data for causing the GUI of the mobile communication device 16 to display one or more traveler pages, in this case, five (5) traveler pages including a traveler page 470, conveying traveler information identifying one or more individuals allowed to travel on flights booked using the RAFP flight pass that has been obtained from the database 42. In this example, the route information specifies names of individuals allowed to travel on flights booked using the RAFP flight pass. The traveler page 470 includes a navigation element 472 allowing the user 14 to view other ones of the traveler pages or all of the travelers' names on one traveler page.

With renewed reference to FIG. 6, in accordance with an embodiment of the invention, the flight pass information page 410 provides an opportunity for the user 14 to make a request to book a flight using the RAFP flight pass. To that end, the flight pass information page 410 includes a flight booking request element 420 that can be acted upon by the user 14 in order to request booking of a flight using the RAFP. In this embodiment, the flight booking request element 420 is a graphical button that can be “clicked” on by the user 14. In other embodiments, the flight booking request element 420 may take on other forms (e.g., a radio button, a hyperlink, etc.).

For purposes of this example, it is assumed that the user 14 desires to book a flight using the RAFP flight pass and thus interacts with the mobile communication device 16 to act on the flight booking request element 420. Upon the user 14 acting on the flight booking request element 420 through interaction therewith (e.g., by pressing on one or more keys thereof), the mobile communication device 16 transmits data indicative that the user 14 acted on the flight booking request element 420 to the communication entity 20.

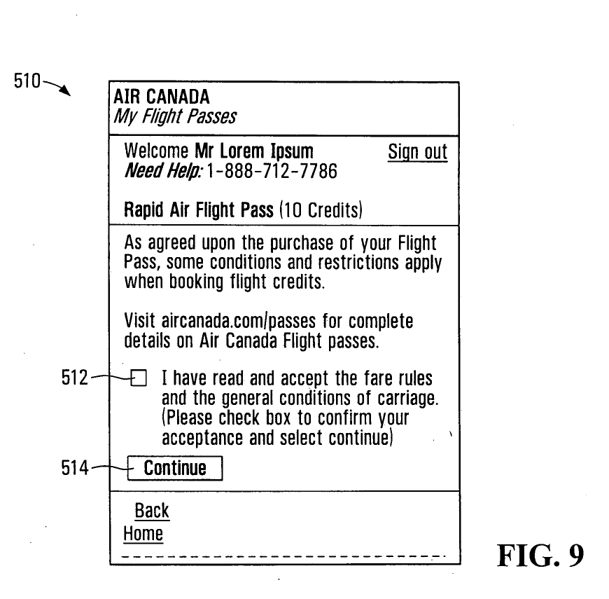

As shown in FIG. 9, upon receiving the data indicative that the user 14 acted on the flight booking request element 420, the communication entity 20 transmits data to cause the GUI of the mobile communication device 16 to display an acceptance page 510 conveying a message notifying the user 14 that certain conditions and restrictions apply when booking flights using the RAFP flight. The acceptance page 510 also includes an acceptance confirmation element 512 allowing the user 14 to confirm his/her acceptance of these conditions and restrictions. More particularly, in this case, the acceptance confirmation element 512 is a checkbox that the user 14 can check by interacting with the mobile communication device 16 in order to confirm his/her acceptance of the conditions and restrictions associated with the RAFP flight pass. Assuming in this example that the user 14 indeed accepts these conditions and restrictions, the user 14 proceeds to interact with the mobile communication device 16 to confirm his/her acceptance via the acceptance confirmation element 512 and then acts on a continue button 514 of the acceptance page 510.

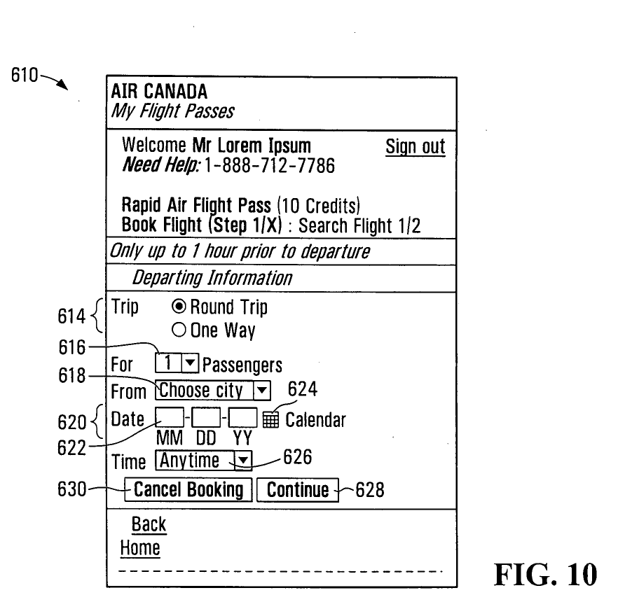

In response to the user 14 acting on the continue button 514, the mobile communication device 16 transmits to the communication entity 20 data indicative that the user 14 confirmed his/her acceptance of the conditions and restrictions associated with the RAFP flight pass via the acceptance confirmation element 512. As shown in FIG. 10, upon receiving this data, the communication entity 20 proceeds to transmit data to cause the GUI of the mobile communication device 16 to display a departure information page 610 allowing the user 14 to provide departure information regarding a flight to be booked using the RAFP flight pass.

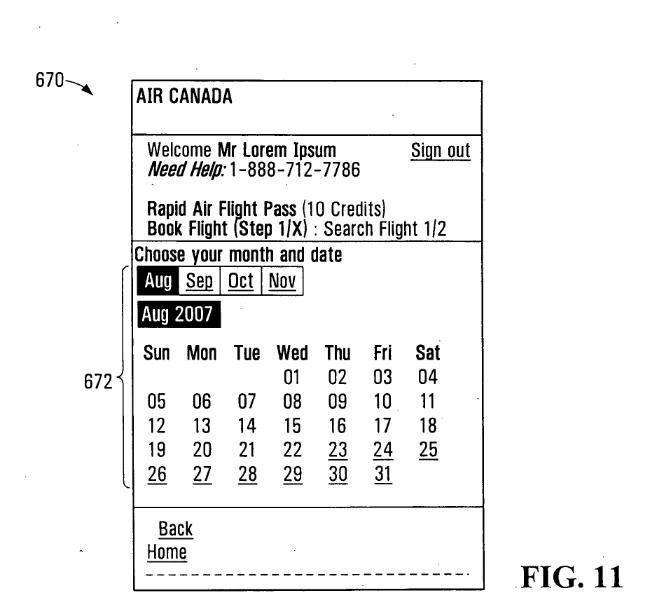

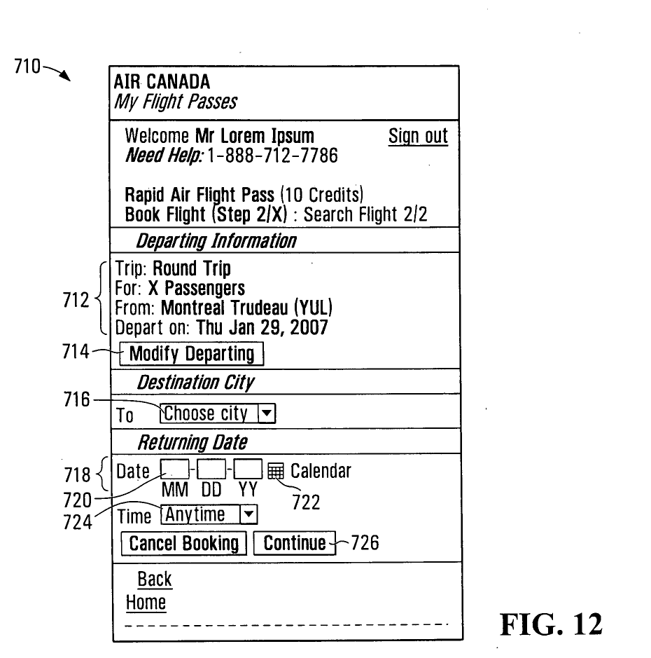

More particularly, in this embodiment, the departure information page 610 includes:
a trip type selection element 614 allowing the user 14 to specify whether he/she desires to book a single flight, i.e., a one-way trip, or a departing flight and a returning flight, i.e., a round trip. In this case, the trip type selection element 614 comprises a radio button which can be moved by the user 14 to specify whether a one-way trip or a round trip is desired. For purposes of this example, it is assumed that the user 14 desires a round trip, i.e., desires to make a request to book a departing flight and a returning flight using the RAFP flight pass, and thus interacts with the mobile communication device 16 to indicate this via the trip type selection element 614;
a passenger number input element 616 allowing the user 14 to specify a number of passengers for which a departing flight and a returning flight are to be booked using the RAFP flight pass. In this case, the passenger number input element 616 comprises a drop down menu which, when acted upon by the user 14, presents a list of possible numbers of passengers and allows the user 14 to select a desired number of passengers therefrom. For purposes of this example, it is assumed that the user 14 specifies via the passenger number input element 616 that three (3) passengers will be needing a departing flight and a returning flight booked using the RAFP flight pass;
a departure location input element 618 allowing the user 14 to specify a location (e.g., a city) from which originates a departing flight and to which returns a returning flight to be booked using the RAFP flight pass. In this case, the departure location input element 618 comprises a drop down menu which, when acted upon by the user 14, presents a list of possible departure locations (in this case, cities) and allows the user 14 to select a desired departure location therefrom. The list of possible departure locations (in this case, cities) may be established based on geographical constraints such as allowed departure locations for flights towards which is applicable the air travel credit in the bank of air travel credit associated with the RAFP flight pass, obtained from the database 42. For purposes of this example, it is assumed that the user 14 specifies via the departure location input element 618 that a departing flight and a returning flight to be booked using the RAFP flight pass respectively depart from and return to Montreal (YUL airport), Quebec, Canada;
a departure date input element 620 allowing the user 14 to specify a departure date at which departs a departing flight to be booked using the RAFP flight pass. In this case, the departure date input element 620 comprises a date field 622 allowing the user 14 to enter textually a desired date as well as a calendar access element 624 that can be acted on by the user 14 to select the desired date using a graphical calendar. More particularly, as shown in FIG. 11, when the user 14 acts on the calendar access element 624, the GUI of the mobile communication device 16 displays a calendar page 670 including a graphical calendar 672. The user 14 may then interact with the mobile communication device 16 to select the desired date using the graphical calendar 672. For purposes of this example, it is assumed that the user 14 specifies a departure date of January 29, 2007 via the departure date input element 620; and
a departure time input element 626 allowing the user 14 to specify a departure time (e.g., morning, afternoon, night, anytime) of a departing flight to be booked using the RAFP flight pass. In this example, the departure time input element 626 comprises a drop down menu which, when acted upon by the user 14, presents a list of possible departure times and allows the user 14 to select a desired departure time therefrom. For purposes of this example, it is assumed that the user 14 does not specify any particular departure time via the departure time input element 626 (e.g., leaves it at “anytime”).

Having provided the departure information. (i.e., three (3) passengers departing from Montreal on Jan. 29, 2007) via the departure information page 610, the user 14 interacts with the mobile communication device 16 to act on a continue button 628 of the departure information page 610. In response, the mobile communication device 16 transmits data conveying the departure information provided by the user 14 to the communication entity 20. Upon reception at the communication entity 20 of the data conveying the departure information provided by the user 14, the processing entity 24 retains this departure information and the communication entity 20 transmits data to cause the GUI of the mobile communication device 16 to display a destination information page 710 allowing the user 14 to specify a destination (e.g., a city) for which is destined a departing flight to be booked using the RAFP flight pass. In this case where a returning flight is also to be booked using the RAFP flight pass, the destination page 710 allows the user 14 to specify return information regarding the returning flight.

More particularly, in this embodiment, the destination information page 710 includes:
an area 712 summarizing the departure information provided by the user 14 and a departure information modification element 714 allowing the user 14 to modify this departure information;
a destination input element 716 allowing the user 14 to specify a destination (e.g., a city) for which is destined a departing flight to be booked using the RAFP flight pass and from which returns a returning flight to be booked using the RAFP flight pass. In this case, the destination input element 716 comprises a drop down menu which, when acted upon by the user 14, presents a list of possible destinations (in this case, cities) and allows the user 14 to select a desired destination therefrom. The list of possible destinations (in this case, cities) may be established based on geographical constraints such as allowed destinations for flights towards which is applicable the air travel credit in the bank of air travel credit associated with the RAFP flight pass, obtained from the database 42. For purposes of this example, it is assumed that the user 14 specifies via the destination input element 716 that a departing flight and a returning flight to be booked using the RAFP flight pass respectively are destined for and return from Vancouver (YVR airport), British Columbia, Canada;
a return date input element 718 allowing the user 14 to specify a return date at which returns a returning flight to be booked using the RAFP flight pass. In this case, the return date input element 718 comprises a date field 720 allowing the user 14 to enter textually a desired date as well as a calendar access element 722 that can be acted on by the user 14 to select the desired date using a graphical calendar, such as the graphical calendar 672 shown in FIG. 11. For purposes of this example, it is assumed that the user 14 specifies a return date of Feb. 3, 2007 via the return date input element 718; and
a return time input element 724 allowing the user 14 to specify a return time (e.g., morning, afternoon, night, anytime) of a returning flight to be booked using the RAFP flight pass. In this example, the return time input element 724 comprises a drop down menu which, when acted upon by the user 14, presents a list of possible return times and allows the user 14 to select a desired return time therefrom. For purposes of this example, it is assumed that the user 14 does not specify any particular return time via the return time input element 724 (e.g., leaves it at “anytime”).

It should be noted that, if the user 14 would have indicated via the trip type selection element 614 of the departure information page 610 that he/she desired to book a one-way trip (i.e., a single flight), the return date input element 718 and the return time input element 724 may be omitted or disabled.

Having provided the destination (i.e., Vancouver) and the return information (i.e., returning on Feb. 3, 2007) via the destination information page 710, the user 14 interacts with the mobile communication device 16 to act on a continue button 726 of the destination information page 710. In response, the mobile communication device 16 transmits data conveying the destination and the return information provided by the user 14 to the communication entity 20.

Upon reception at the communication entity 20 of the data conveying the destination and the return information provided by the user 14, and having previously obtained the departure information provided by the user 14, the processing entity 24 interacts with reservation entity 34 to request a list of departing flights and a list of returning flights that corresponds to departure information, destination and return information provided by the user 14. More particularly, in this case, the processing entity 24 interacts with the reservation entity 34 to request a list of departing flights for three (3) passengers departing on Jan. 29, 2007 from Montreal in destination of Vancouver and a list of returning flights for three (3) passengers departing on Feb. 3, 2007 from Vancouver in destination of Montreal. The reservation entity 34 consults the database 44 to establish such a list of departing flights and such a list of returning flights.

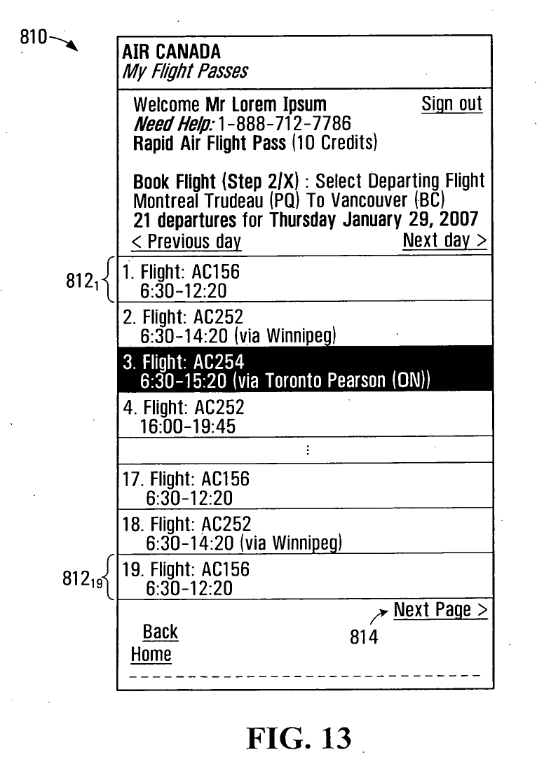

As shown in FIG. 13, upon having established these lists, the reservation entity 34 communicates them to the processing entity 24, which causes the communication entity 20 to transmit data for causing the GUI of the mobile communication device 16 to display one or more departing flight list pages, in this case two (2) departing flight list pages including a departing flight list page 810, which convey a list of departing flights (containing, in this case, twenty-one (21) flights) for three (3) passengers departing on Jan. 29, 2007 from Montreal in destination of Vancouver. More particularly, the departing flight list pages include a plurality of areas 812₁ . . . 812₂₁, where each area 812ᵢ conveys information regarding a given departing flight of the list of departing flights that has been obtained from the database 44. For example, in this embodiment, the information regarding the given departing flight includes: a flight identifier of the given departing flight, a departure time of the given departing flight and an arrival time of the given departing flight. A flight, as used herein, can sometimes include one or more intermediate stops or connections, in which case it can be viewed as a combination of flight segments. In this embodiment, if the given departing flight involves one or more intermediate stops or connections, the information regarding the given departing flight includes an indication of such one or more intermediate stops or connections (e.g., “via Toronto Pearson”). By interacting with the mobile communication device 16, the user 14 can scroll up and down each of the departing flight list pages to view different departing flights of the list of departing flights. Each of the departing flight list pages includes a navigation element 814 allowing the user 14 to move from one page to another.

The user 14 can interact with the mobile communication device 16 to select a given departing flight of the list of departing flights in order to request booking of the given departing flight. For purposes of this example, it is assumed that the user 14 interacts with the mobile communication device 16 to select the departing flight identified as “AC254” which is associated with the area 812₃ of the departing flight list page 810 and which will hereinafter be referred to as the “AC254 flight”. In response to the user 14 selecting the AC254 flight through interaction therewith (e.g., by pressing on one or more keys thereof), the mobile communication device 16 transmits data indicative that the user 14 selected the AC254 flight to the communication entity 20.

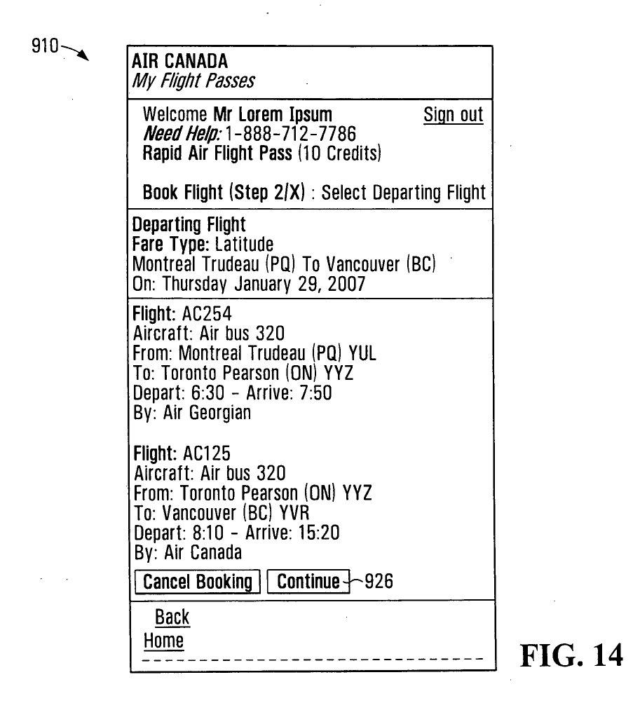

As shown in FIG. 14, upon reception at the communication entity 20 of the data indicative that the user 14 selected the AC254 flight, the processing entity 24 takes note of this selection and causes the communication entity 20 to transmit data for causing the GUI of the mobile communication device 16 to display a departing flight information page 910 conveying information regarding the AC254 flight that has been obtained from the database 44. For example, in this embodiment, and in this case where the AC254 flight involves a connection with a connecting flight AC125 in Toronto, the information regarding the AC254 flight includes: a flight identifier of the AC254 flight, an aircraft type of the AC254 flight, a departure time of the AC254 flight, an arrival time of the AC254 flight in Toronto, a flight identifier of the AC125 connecting flight, an aircraft type of the AC125 connecting flight, a departure time of the AC125 connecting flight, and an arrival time of the AC125 connecting flight in Vancouver.

Upon having reviewed the departing flight information page 910, the user 14 interacts with the mobile communication device 16 to act on a continue button 926 of the departing flight information page 910. In response, the mobile communication device 16 transmits data indicative that the user 14 has acted on the continue button 926 to the communication entity 20.

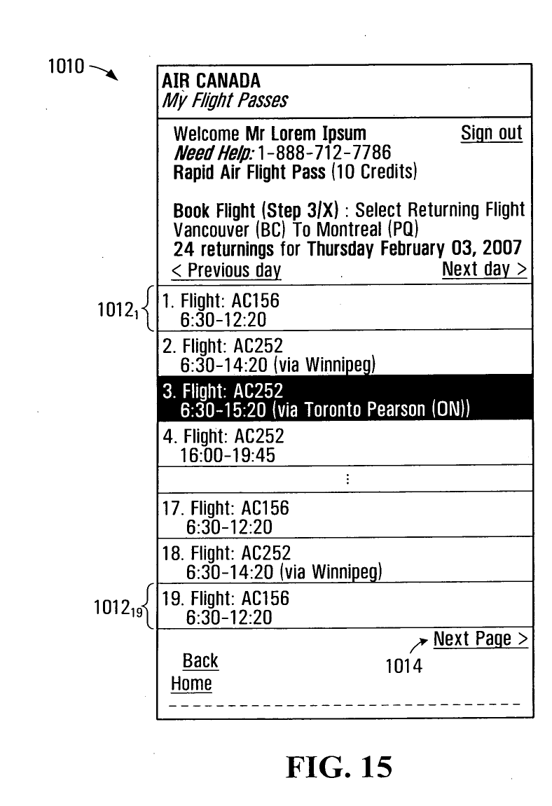

As shown in FIG. 15, upon reception at the communication entity 20 of the data indicative that the user 14 has acted on the continue button 926 of the communication entity 20, the processing entity 24 causes the communication entity 20 to transmit data for causing the GUI of the mobile communication device 16 to display one or more returning flight list pages, in this case two (2) returning flight list pages including a returning flight list page 1010, which convey a list of returning flights (containing, in this case, twenty-four (24) flights) for three (3) passengers departing on Feb. 3, 2007 from Vancouver in destination of Montreal. More particularly, the returning flight list pages include a plurality of areas 1012₁ . . . 1012₂₄, where each area 1012ᵢ conveys information regarding a given returning flight of the list of returning flights that has been obtained from the database 44. For example, in this embodiment, the information regarding the given returning flight includes: a flight identifier of the given returning flight, a departure time of the given returning flight and an arrival time of the given returning flight. As mentioned previously, a flight, as used herein, can sometimes include one or more intermediate stops or connections, in which case it can be viewed as a combination of flight segments. In this embodiment, if the given returning flight involves one or more intermediate stops or connections, the information regarding the given returning flight includes an indication of such one or more intermediate stops or connections (e.g., “via Toronto Pearson”). By interacting with the mobile communication device 16, the user 14 can scroll up and down each of the returning flight list pages to view different returning flights of the list of returning flights. Each of the returning flight list pages includes a navigation element 1014 allowing the user 14 to move from one page to another.

The user 14 can interact with the mobile communication device 16 to select a given returning flight of the list of returning flights in order to request booking of the given returning flight. For purposes of this example, it is assumed that the user 14 interacts with the mobile communication device 16 to select the returning flight identified as “AC252” which is associated with the area 1012₃ of the departing flight list page 810 and which will hereinafter be referred to as the “AC252 flight”. In response to the user 14 selecting the AC252 flight through interaction therewith (e.g., by pressing on one or more keys thereof), the mobile communication device 16 transmits data indicative that the user 14 selected the AC252 flight to the communication entity 20.

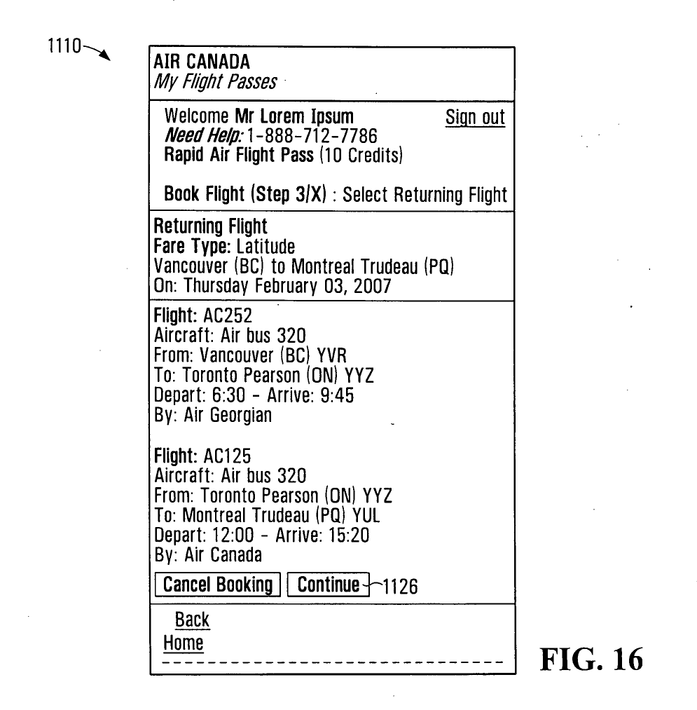

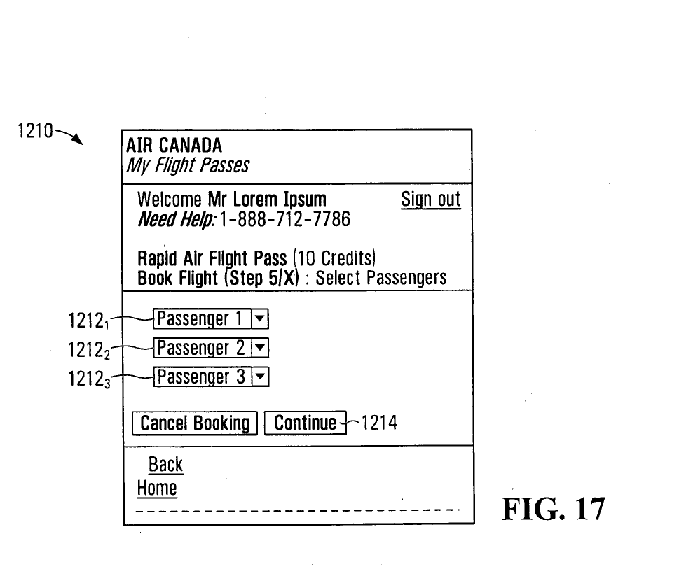

As shown in FIG. 16, upon reception at the communication entity 20 of the data indicative that the user 14 selected the AC252 flight, the processing entity 24 takes note of this selection and causes the communication entity 20 to transmit data for causing the GUI of the mobile communication device 16 to display a returning flight information page 1110 conveying information regarding the AC252 flight that has been obtained from the database 44. For example, in this embodiment, and in this case where the AC252 flight involves a connection with a connecting flight AC125 in Toronto, the information regarding the AC252 flight includes: a flight identifier of the AC252 flight, an aircraft type of the AC252 flight, a departure time of the AC252 flight, an arrival time of the AC252 flight in Toronto, a flight identifier of the AC125 connecting flight, an aircraft type of the AC125 connecting flight, a departure time of the AC125 connecting flight, and an arrival time of the AC125 connecting flight in Montreal. Upon having reviewed the returning flight information page 1110, the user 14 interacts with the mobile communication device 16 to act on a continue button 1126 of the returning flight information page 1110. In response, the mobile communication device 16 transmits data indicative that the user 14 has acted on the continue button 1126 to the communication entity 20.

Knowing that the user 14 has selected the AC254 flight and the AC252 flight for three (3) passengers, the processing entity 24 interacts with the flight pass management entity 38 in order to cause the communication entity 20 to transmit data for causing the GUI of the mobile communication device 16 to display a passenger selection page 1210 allowing the user 14 to specify an identity of each of these passengers. More particularly, in this embodiment, the passenger selection page 1210 includes three (3) passenger identity input elements 1212₁ . . . 1212₃ allowing the user 14 to specify an identity of each of the three (3) passengers for which the AC254 flight and the AC252 flight are to be booked using the RAFP flight pass. In this case, each passenger identity input element 1212i comprises a drop down menu which, when acted upon by the user 14, presents a list of possible passenger identities (in this case, names) and allows the user 14 to select a desired passenger identity therefrom. The list of possible passenger identities (in this case, names) may be established based on the traveler information associated with the RAFP flight pass in the database 42. For purposes of this example, it is assumed that the user 14 interacts with the mobile communication device 16 to specify via passenger identity input elements 1212₁ . . . 1212₃ the that the three (3) passengers for which the AC254 flight and the AC252 flight are to be booked using the RAFP flight pass are Jack Ruth, John Smith and Marc Wong. The user 14 proceeds to interact with the mobile communication device 16 to act on a continue button 1214 of the passenger selection page 1210. In response, the mobile communication device 16 transmits data indicative that the three (3) passengers for which the AC254 flight and the AC252 flight are to be booked using the RAFP flight pass are Jack Ruth, John Smith and Marc Wong.

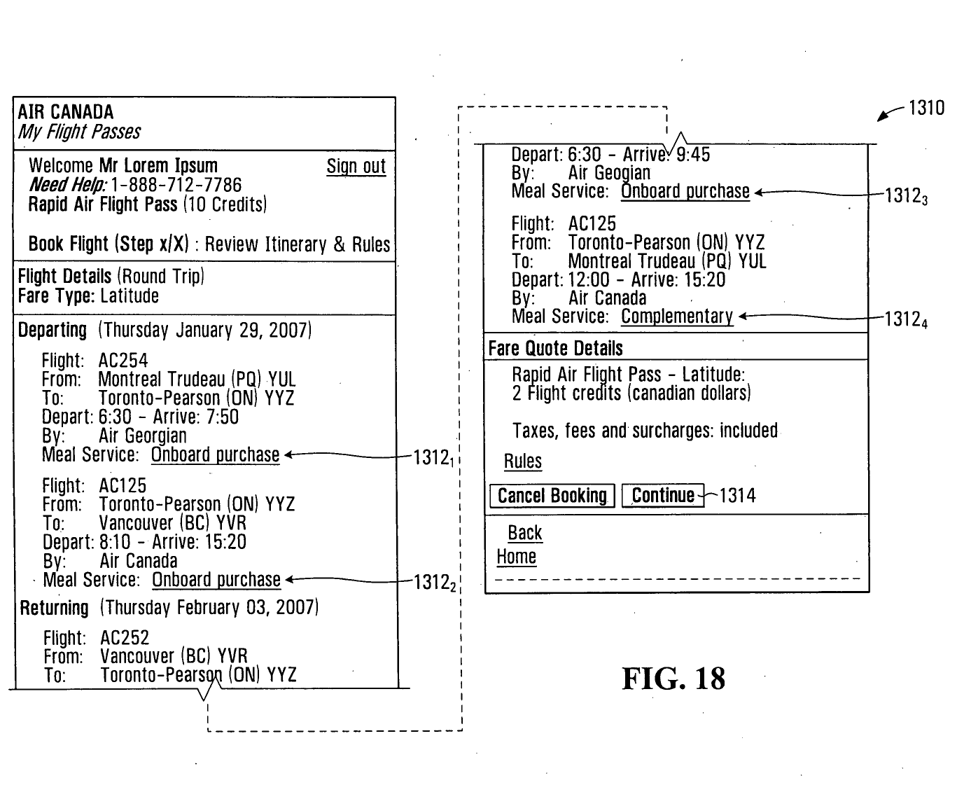

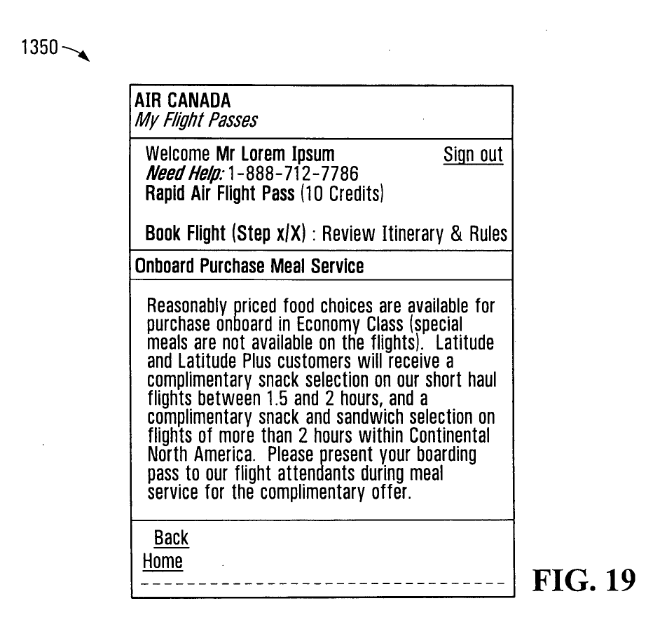

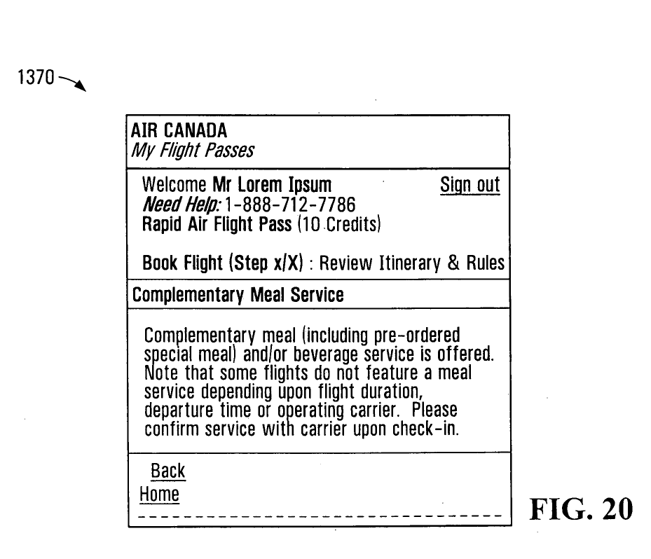

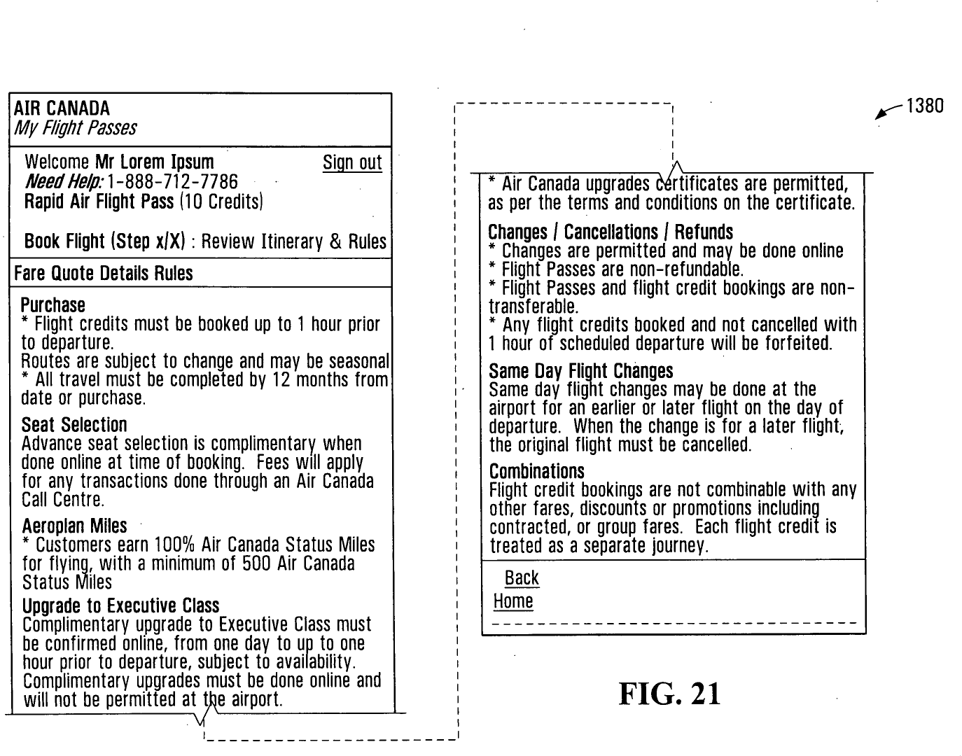

As shown in FIG. 18, upon reception at the communication entity 20 of the data indicative that the three (3) passengers for which the AC254 flight and the AC252 flight are to be booked using the RAFP flight pass are Jack Ruth, John Smith and Marc Wong, the processing entity 24 takes notes of this information and causes the communication entity 20 to transmit data for causing the GUI of the mobile communication device 16 to display an itinerary review page 1310, which presents information summarizing an itinerary selected by the user 14. More particularly, the itinerary review page 1310 presents information regarding the AC254 flight and the AC252 flight (and their associated connecting flights) to be booked using the RAFP flight pass. The itinerary review page 1310 also includes a plurality of meal service information elements 1312₁ . . . 1312₄ allowing the user 14 to obtain information regarding a meal service for each flight. For instance, when the user 14 acts upon the meal service information elements 1312₁ indicating that the meal service for the AC254 flight is an onboard purchase meal service, the GUI of the mobile communication device 16 displays a meal service information page 1350 as shown in FIG. 19, whereas when the user 14 acts upon the meal service information elements 1312₄ indicating that the meal service for the AC125 connecting flight is a complementary meal service, the GUI of the mobile communication device 16 displays a meal service information page 1370 as shown in FIG. 20. The itinerary review page 1310 further includes a rule information element 1316 allowing the user 14 to obtain information regarding rules and conditions applicable to booking of the AC254 flight and the AC252 flight using the RAFP flight pass. For example, when the user 14 acts upon the rule information element 1316, the GUI of the mobile communication device 16 displays a rule information page 1380, as shown in FIG. 21, which conveys information about various rules and conditions applicable to booking of the AC254 flight and the AC252 flight using the RAFP flight pass.

Having reviewed the itinerary review page 1310, the user 14 interacts with the mobile communication device 16 to act on a continue button 1314 of the itinerary review page 1310. In response, the mobile communication device 16 transmits data indicative that the user 14 has acted on the continue button 1314 to the communication entity 20.

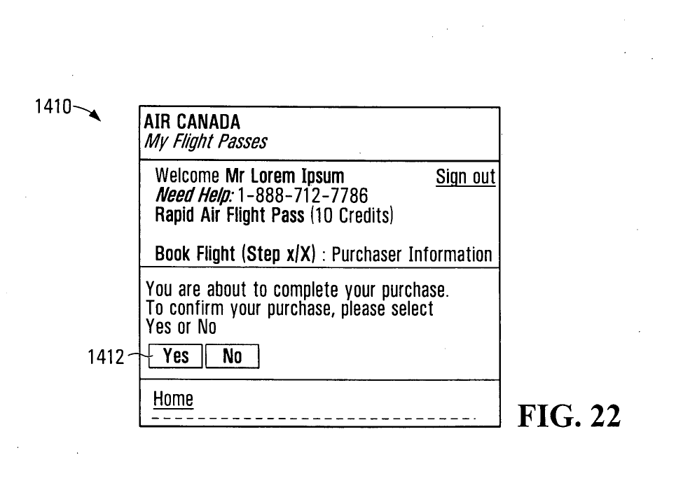

As shown in FIG. 22, upon receiving the data indicative that the user 14 has acted on the continue button 1314, the communication entity 20 transmits data to cause the GUI of the mobile communication device 16 to display a booking confirmation page 1410 allowing the user 14 to confirm his/her desire to book the AC254 flight and the AC252 flight for Jack Ruth, John Smith and Marc Wong using the RAFP flight pass. More particularly, in this embodiment, the booking confirmation page 1410 conveys a message prompting the user 14 to confirm his/her desire to proceed with this booking and includes a booking confirmation element 1412 which can be acted on by the user 14 in order to do so. Assuming that the user 14 indeed wishes to confirm his/her desire to book the AC254 flight and the AC252 flight for Jack Ruth, John Smith and Marc Wong using the RAFP flight pass, he/she interacts with the mobile communication device 16 to act on the booking confirmation element 1412 to confirm this desire. In response, the mobile communication device 16 transmits data indicative that the user 14 has acted on the booking confirmation element 1412 to confirm his/her desire to proceed with the booking.

Upon reception at the communication entity 20 of the data indicative that the user 14 has acted on the booking confirmation element 1412 to confirm his/her desire his/her desire to book the AC254 flight and the AC252 flight for Jack Ruth, John Smith and Marc Wong using the RAFP flight pass, the processing entity 24 interacts with the reservation entity 34 in order to cause the reservation entity 34 to effect a booking of the AC254 flight and the AC252 flight for Jack Ruth, John Smith and Marc Wong using the RAFP flight pass. This booking can be effected in various known ways by the reservation entity 34 and as such will not be described further herein.

The processing entity 24 also interacts with the flight pass management entity 38 in order to cause the flight pass management entity 39 to effect a reduction in the bank of air travel credit associated with the RAFP flight pass, in accordance with an amount of air travel credit applied to book the AC254 flight and the AC252 flight for Jack Ruth, John Smith and Marc Wong using the RAFP flight pass. To that end, the flight pass management entity 38 modifies the remaining credit information contained in the particular one of the records 50₁ . . . 50_{N} in the database 42 that is associated with the RAFP flight pass to reflect the amount of air travel credit remaining following booking of the AC254 flight and the AC252 flight for Jack Ruth, John Smith and Marc Wong using the RAFP flight pass.

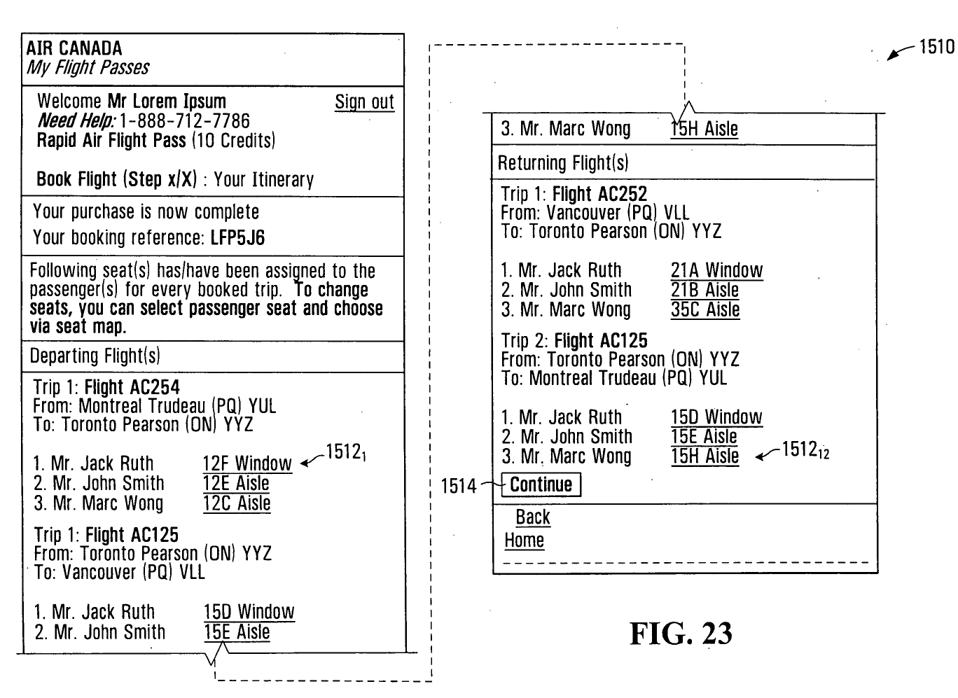

Once the booking is completed, as shown in FIG. 23, the processing entity 24 causes the communication entity 20 to transmit data for causing the GUI of the mobile communication device 16 to display a completed booking page 1510 to convey to the user 14 that the booking of the AC254 flight and the AC252 flight for Jack Ruth, John Smith and Marc Wong using the RAFP flight pass has been completed. The completed booking page 1510 conveys to the user 14 a booking reference (in this case, LFP5J6) associated with this booking.

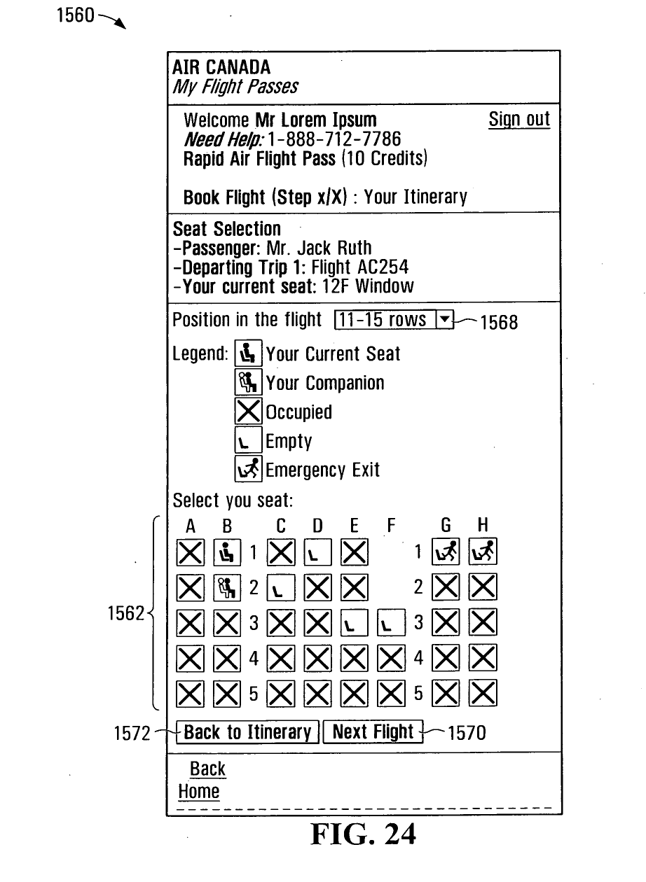

The completed booking page 1510 also conveys to the user 14 information regarding seats that have been assigned to Jack Ruth, John Smith and Marc Wong for the flights that have been booked. These seats have been assigned automatically by the reservation entity 34 upon effecting the booking of the flights. In this embodiment, the completed booking page 1510 includes a plurality of seat selection elements 1512₁ . . . 1512₁₂ allowing the user to select specific seats for Jack Ruth, John Smith and Marc Wong on the flights that have been booked. For example, when the user 14 interacts with the mobile communication device 16 to act on the seat selection element 1512₁ for selecting a specific seat for Jack Ruth on the AC254 flight, the mobile communication device 16 transmits data indicative that the user 14 acted on the seat selection element 1512₁ to the communication entity 20. Upon reception of this data at the communication entity 20, the processing entity 24 interacts with the reservation entity 34 to obtain information regarding a seat configuration on the AC254 flight, including available seats, occupied seats and possibly other seating information (e.g., seats adjacent to emergency exits), which is obtained from the database 44. Based on this information, the processing entity 24 causes the communication entity 20 to transmit data for causing the GUI of the mobile communication device 16 to display a seat selection page 1560, as shown in FIG. 24.

The seat selection page 1560 includes a seat map 1562 that conveys to the user 14 positions of seats on the AC254 flight. The seat map 1562 also indicates using different symbols and colors a current seat assigned to Jack Ruth, which seats are available, and which seats are occupied. In this case, the seat map 1562 also indicates a current seat assigned to a flight companion of Jack Ruth (John Smith or Marc Wong), as well as which seats are adjacent to emergency exits. Five (5) rows of seats (in this case, rows 11 to 15) of the seat map 1562 are currently shown in the seat selection page 1560, which includes a row viewing element 1568 that can be acted on by the user 14 to view other rows of seats of the seat map 1562.

By interacting with the mobile communication device 16 (e.g., pressing on one or more keys), the user 14 can select a specific seat for Jack Ruth on the AC254 flight with reference to the seat map 1562 (e.g., by clicking on the specific seat in question). Alternatively or additionally, the user 14 can interact with the mobile communication device 16 to act on a next flight button 1570 to view a seat map for the connecting flight AC125. For purposes of this example, it is assumed that the user 14 decides to keep the current seat that has been automatically assigned to Jack Ruth on the AC254 flight and proceeds to interact with the mobile communication device 16 to act on a completed booking page button 1572 to return to the completed booking page 1510.

Having reviewed the completed booking page 1510, the user 14 interacts with the mobile communication device 16 to act on a continue button 1514 of the completed booking page 1510. In response, the mobile communication device 16 transmits data indicative that the user 14 has acted on the continue button 1514.

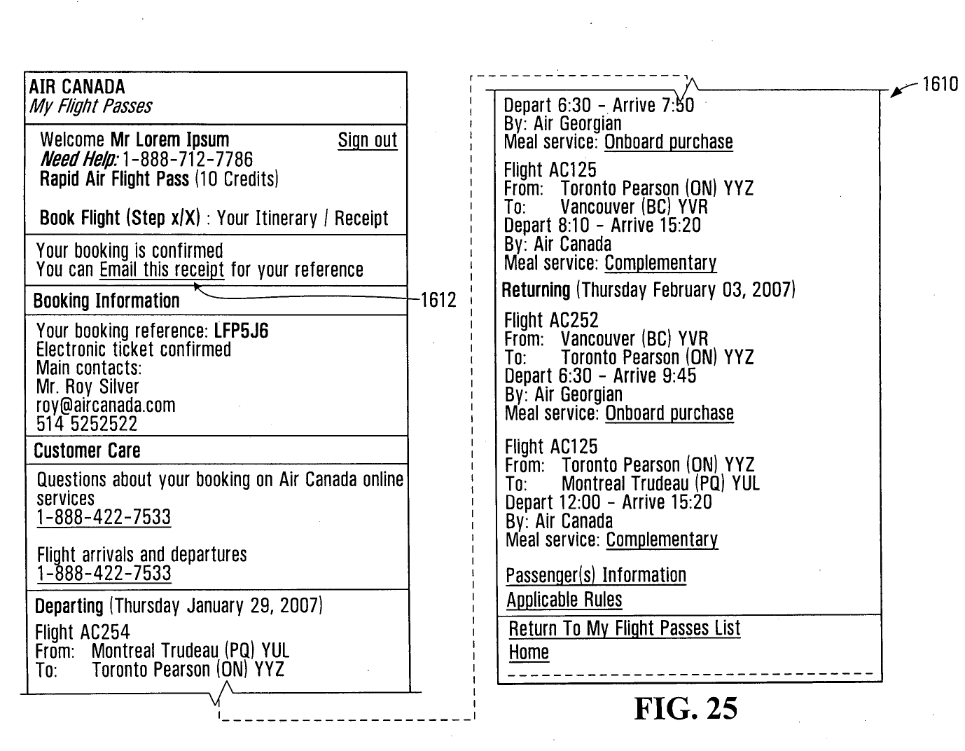

As shown in FIG. 25, upon receiving the data indicative that the user 14 has acted on the continue button 1514, the communication entity 20 transmits data to cause the GUI of the mobile communication device 16 to display an itinerary/receipt page 1610 conveying to the user 14 the booking reference (in this case, LFP5J6) associated with the booking, information summarizing the itinerary selected by the user 14, as well as certain customer service contact information.

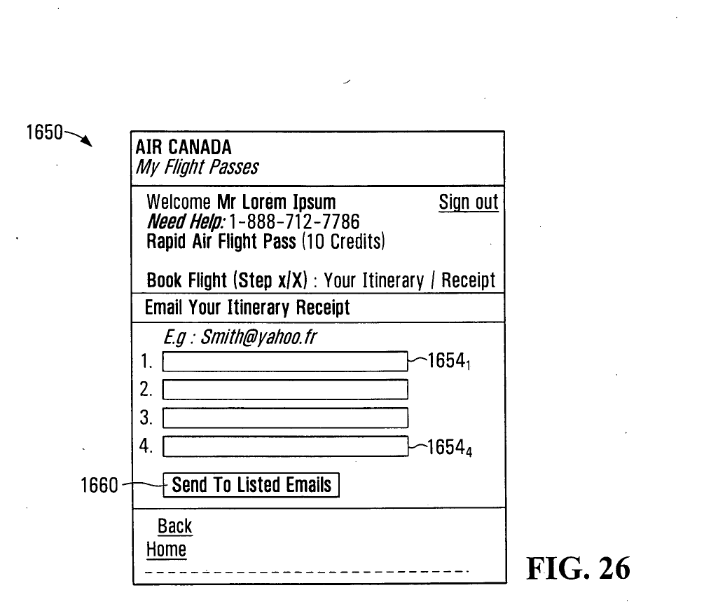

The itinerary/receipt page 1610 also includes an email receipt request element 1612 allowing the user 14 to request an email message conveying a receipt of the booking to be sent to one or more email addresses. More particularly, in this embodiment, when the user 14 interacts with the mobile communication device 16 to act on the email receipt request element 1612, the GUI of the mobile communication device 16 displays an email address input page 1650, as shown in FIG. 26. The email address input page 1650 includes a plurality of email address input fields 1654₁ . . . 1654₅ allowing the user 14 to input, in this case, up to five email addresses to which an email message conveying a receipt of the booking is to be sent. For purposes of this example, it is assumed that the user 14 interacts with the mobile communication device 16 to enter in the email address input fields 1654₁ and 1654₂ the email addresses “smith@yahoo.fr” and “Christine.madame@yahoo.fr”. After having entered these email addresses, the user 14 proceeds to interact with the mobile communication device 16 to act on a send email button 1660. In response, the mobile communication device 16 transmits data indicative of the email addresses “smith@yahoo.fr” and “Christine.madame@yahoo.fr” to the communication entity 20.

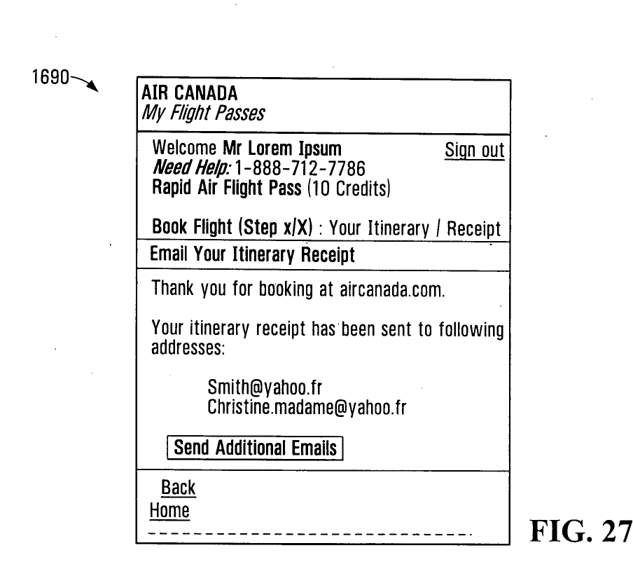

Upon reception at the communication entity 20 of the data indicative of the email addresses “smith@yahoo.fr” and “Christine.madame@yahoo.fr”, the processing entity 24 proceeds to cause transmission of an email message conveying a receipt of the booking to each of the email addresses “smith@yahoo.fr” and “Christine.madame@yahoo.fr”. For example, in some embodiments, the processing entity 24 may be in communication with an email server (not shown) and may interact therewith to cause transmission of the email message to each of these email addresses. The receipt of the booking may include some or all of the information conveyed by the itinerary/receipt page 1610 and/or various other information (e.g., seats for Jack Ruth, John Smith and Marc Wong on the different flights that have been booked). As shown in FIG. 27, once the email message conveying the receipt of the booking has been transmitted to each of the email addresses “smith@yahoo.fr” and “Christine.madame@yahoo.fr”, the processing entity 24 causes the communication entity 20 to transmit data for causing the GUI of the mobile communication device 16 to display an email transmission confirmation page 1690, which confirms to the user 14 that this email message transmission has been completed.

It will thus be appreciated that the mobile flight pass service contemplated herein enables the user 14 to obtain various information regarding a flight pass and make a request to book a flight using the flight pass by using the mobile communication device 16 to access the site implemented by the communication entity 20. In particular, through its sequence of pages, the site implemented by the communication entity 20 allows the user 14 to use the mobile communication device 16 to conveniently book a flight using a flight pass, taking into account a relatively large number of steps involved in such a booking process and a limited amount of screen real estate of the mobile communication device 16. This ability to use the mobile communication device 16 to conveniently book a flight using a flight pass can be particularly useful to the user 14, for instance, if he/she is a business or other traveler that needs to book flights on the go and/or on short notice (e.g., up to two (2) hours prior to departure).

Those skilled in the art will appreciate that, in some embodiments, certain functionality of a given component described herein (e.g., the communication entity 20, the processing entity 24) may be implemented as pre-programmed hardware or firmware elements (e.g., application specific integrated circuits (ASICs), electrically erasable programmable read-only memories (EEPROMs), etc.) or other related elements. In other embodiments, a given component described herein (e.g., the communication entity 20, the processing entity 24) may comprise a general-purpose processor having access to storage media that is fixed, tangible, and readable by the general-purpose processor and that stores program code for operation of the general-purpose processor to implement functionality of that given component. The storage media may store data optically (e.g., an optical disk such as a CD-ROM or a DVD), magnetically (e.g., a hard disk drive, a removable diskette), electrically (e.g., semiconductor memory, including ROM such as EPROM, EEPROM and Flash memory, or RAM), or in any another suitable way. Alternatively, the program code may be stored remotely but transmittable to the given component via a modem or other interface device connected to a network over a transmission medium. The transmission medium may be either a tangible medium (e.g., optical or analog communications lines) or a medium implemented using wireless techniques (e.g., RF, microwave, infrared or other wireless transmission schemes).

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A method for enabling a user of a mobile communication device to use a flight pass that is associated with a bank of air travel credit applicable to book flights, said method comprising:
transmitting data conveying information regarding the flight pass to be presented to the user via a graphical user interface of the mobile communication device;
receiving data conveying a request to book a flight using the flight pass made by the user via the graphical user interface of the mobile communication device; and
causing a booking of the flight using the flight pass.

2. A method as claimed in claim 1, comprising causing a reduction in the bank of air travel credit corresponding to an amount of air travel credit applied to book the flight using the flight pass.

3. A method as claimed in claim 1, comprising:
receiving data conveying departure information provided by the user via the graphical user interface of the mobile communication device;
determining, based on the departure information, a list of flights bookable using the flight pass; and
transmitting data conveying the list of flights to be presented to the user via the graphical user interface of the mobile communication device;
wherein the data conveying the request to book the flight using the flight pass comprises data conveying a selection of the flight from the list of flights made by the user via the graphical user interface of the mobile communication device.

4. A method as claimed in claim 3, wherein the departure information comprises a departure location and a departure date, said method comprising transmitting data to cause the graphical user interface of the mobile communication device to present a location input element allowing the user to provide the departure location and a date input element allowing the user to provide the departure date.

5. A method as claimed in claim 4, wherein the location input element allows the user to provide the departure location by selecting the departure location from a list of locations.

6. A method as claimed in claim 5, wherein the flight pass is associated with geographical constraints regarding flights towards which is applicable air travel credit in the bank of air travel credit, said method comprising determining the list of locations based on the geographical constraints.

7. A method as claimed in claim 4, wherein the date input element comprises a calendar allowing the user to provide the departure date by selecting the departure date from the calendar.

8. A method as claimed in claim 4, wherein the location input element, the date input element, and the list of flights are presented to the user on at least two pages sequentially displayed on the graphical user interface of the mobile communication device.

9. A method as claimed in claim 1, comprising transmitting data to cause the graphical user interface of the mobile communication device to present a seat selection element allowing the user to select a seat on the flight.

10. A method as claimed in claim 1, comprising transmitting data to cause the graphical user interface of the mobile communication device to present a seat map allowing the user to select a seat on the flight with reference to the seat map.

11. A method as claimed in claim 1, comprising receiving data conveying passenger information for the flight provided by the user via the graphical user interface of the mobile communication device.

12. A method as claimed in claim 1, comprising:
receiving data conveying an email address provided by the user via the graphical user interface of the mobile communication device and to which a receipt of booking of the flight is to be emailed; and
causing transmission of an email message conveying the receipt of booking of the flight to the email address.

13. A method as claimed in claim 1, wherein the flight is a departing flight and the request to book the departing flight using the flight pass is a request to book the departing flight and a returning flight using the flight pass.

14. A method as claimed in claim 13, comprising:
receiving data conveying departure information and return information provided by the user via the graphical user interface of the mobile communication device;
determining, based on the departure information, a list of departing flights bookable using the flight pass;
determining, based on the return information, a list of returning flights bookable using the flight pass;
transmitting data conveying the list of departing flights and the list of returning flights to be presented to the user via the graphical user interface of the mobile communication device;
wherein the data conveying the request to book the departing flight and the returning flight using the flight pass comprises data conveying a selection of the departing flight from the list of departing flights made by the user via the graphical user interface of the mobile communication device and data conveying a selection of the returning flight from the list of returning flights made by the user via the graphical user interface of the mobile communication device.

15. A method as claimed in claim 14, wherein the departure information comprises a departure location and a departure date and the return information comprises a return date, said method comprising transmitting data to cause the graphical user interface of the mobile communication device to present a location input element allowing the user to provide the departure location, a departure date input element allowing the user to provide the departure date, and a return date element allowing the user to provide the return date.

16. A method as claimed in claim 15, wherein the location input element allows the user to provide the departure location by selecting the departure location from a list of locations.

17. A method as claimed in claim 16, wherein the flight pass is associated with geographical constraints regarding flights towards which is applicable air travel credit in the bank of air travel credit, said method comprising determining the list of locations based on the geographical constraints.

18. A method as claimed in claim 15, wherein the departure date input element comprises a first calendar allowing the user to provide the departure date by selecting the departure date from the first calendar and the return date input element comprises a second calendar allowing the user to provide the return date by selecting the return date from the second calendar.

19. A method as claimed in claim 15, wherein the location input element, the departure date input element, the return date input element, the list of departing flights and the list of returning flights are presented to the user on at least three pages sequentially displayed on the graphical user interface of the mobile communication device.

20. A method as claimed in claim 13, comprising transmitting data to cause the graphical user interface of the mobile communication device to present a first seat selection element allowing the user to select a seat on the departing flight and a second seat selection element allowing the user to select a seat on the returning flight.

21. A method as claimed in claim 13, comprising transmitting data to cause the graphical user interface of the mobile communication device to present a first seat map allowing the user to select a seat on the departing flight with reference to the first seat map and a second seat map allowing the user to select a seat on the returning flight with reference to the second seat map.

22. A method as claimed in claim 13, comprising receiving data conveying passenger information for the departing flight and the returning flight provided by the user via the graphical user interface of the mobile communication device.

23. A method as claimed in claim 13, comprising:
receiving data conveying an email address provided by the user via the graphical user interface of the mobile communication device and to which a receipt of booking of the departing flight and the returning flight is to be emailed; and
causing transmission of an email message conveying the receipt of booking of the departing flight and the returning flight to the email address.

24. A method as claimed in claim 1, wherein the information regarding the flight pass comprises at least one of: an identifier of the flight pass; an amount of air travel credit remaining in the bank of air travel credit; routes available for booking flights using the flight pass; a name of each of at least one individual eligible to be a passenger on flights booked using the flight pass; an expiry date of the flight pass; and a name of an owner of the flight pass.

25. A method as claimed in claim 1, comprising, prior to said transmitting, said receiving and said causing the booking:
receiving data conveying authentication information provided by the user via the graphical user interface of the mobile communication device; and
granting the user access to the flight pass via the graphical user interface of the mobile communication device upon the authentication information having been validated.

26. A system for enabling a user of a mobile communication device to use a flight pass that is associated with a bank of air travel credit applicable to book flights, said system comprising:
a communication entity configured for:
transmitting data conveying information regarding the flight pass to be presented to the user via a graphical user interface of the mobile communication device; and
receiving data conveying a request to book a flight using the flight pass made by the user via the graphical user interface of the mobile communication device; and
a processing entity configured for causing a booking of the flight using the flight pass.

27. A system as claimed in claim 26, said processing entity being configured for causing a reduction in the bank of air travel credit corresponding to an amount of air travel credit applied to book the flight using the flight pass.

28. A system as claimed in claim 26, said communication entity being configured for receiving data conveying departure information provided by the user via the graphical user interface of the mobile communication device, said processing entity being configured for determining, based on the departure information, a list of flights bookable using the flight pass, said communication entity being configured for transmitting data conveying the list of flights to be presented to the user via the graphical user interface of the mobile communication device, wherein the data conveying the request to book the flight using the flight pass comprises data conveying a selection of the flight from the list of flights made by the user via the graphical user interface of the mobile communication device.

29. A system as claimed in claim 28, wherein the departure information comprises a departure location and a departure date, said communication entity being configured for transmitting data to cause the graphical user interface of the mobile communication device to present a location input element allowing the user to provide the departure location and a date input element allowing the user to provide the departure date.

30. A system as claimed in claim 29, wherein the location input element allows the user to provide the departure location by selecting the departure location from a list of locations.

31. A system as claimed in claim 30, wherein the flight pass is associated with geographical constraints regarding flights towards which is applicable air travel credit in the bank of air travel credit, said processing entity being configured for determining the list of locations based on the geographical constraints.

32. A system as claimed in claim 29, wherein the date input element comprises a calendar allowing the user to provide the departure date by selecting the departure date from the calendar.

33. A system as claimed in claim 29, wherein the location input element, the date input element, and the list of flights are presented to the user on at least two pages sequentially displayed on the graphical user interface of the mobile communication device.

34. A system as claimed in claim 26, said communication entity being configured for transmitting data to cause the graphical user interface of the mobile communication device to present a seat selection element allowing the user to select a seat on the flight.

35. A system as claimed in claim 26, said communication entity being configured for transmitting data to cause the graphical user interface of the mobile communication device to present a seat map allowing the user to select a seat on the flight with reference to the seat map.

36. A system as claimed in claim 26, said communication entity being configured for receiving data conveying passenger information for the flight provided by the user via the graphical user interface of the mobile communication device.

37. A system as claimed in claim 26, said communication entity being configured for receiving data conveying an email address provided by the user via the graphical user interface of the mobile communication device and to which a receipt of booking of the flight is to be emailed, said processing entity being configured for causing transmission of an email message conveying the receipt of booking of the flight to the email address.

38. A system as claimed in claim 26, wherein the flight is a departing flight and the request to book the departing flight using the flight pass is a request to book the departing flight and a returning flight using the flight pass.

39. A system as claimed in claim 38, said communication entity being configured for receiving data conveying departure information and return information provided by the user via the graphical user interface of the mobile communication device, said processing entity being configured for determining, based on the departure information, a list of departing flights bookable using the flight pass and for determining, based on the return information, a list of returning flights bookable using the flight pass, said communication entity being configured for transmitting data conveying the list of departing flights and the list of returning flights to be presented to the user via the graphical user interface of the mobile communication device, wherein the data conveying the request to book the departing flight and the returning flight using the flight pass comprises data conveying a selection of the departing flight from the list of departing flights made by the user via the graphical user interface of the mobile communication device and data conveying a selection of the returning flight from the list of returning flights made by the user via the graphical user interface of the mobile communication device.

40. A system as claimed in claim 39, wherein the departure information comprises a departure location and a departure date and the return information comprises a return date, said communication entity being configured for transmitting data to cause the graphical user interface of the mobile communication device to present a location input element allowing the user to provide the departure location, a departure date input element allowing the user to provide the departure date, and a return date element allowing the user to provide the return date.

41. A system as claimed in claim 40, wherein the location input element allows the user to provide the departure location by selecting the departure location from a list of locations.

42. A system as claimed in claim 41, wherein the flight pass is associated with geographical constraints regarding flights towards which is applicable air travel credit in the bank of air travel credit, said processing entity being configured for determining the list of locations based on the geographical constraints.

43. A system as claimed in claim 40, wherein the departure date input element comprises a first calendar allowing the user to provide the departure date by selecting the departure date from the first calendar and the return date input element comprises a second calendar allowing the user to provide the return date by selecting the return date from the second calendar.

44. A system as claimed in claim 40, wherein the location input element, the departure date input element, the return date input element, the list of departing flights and the list of returning flights are presented to the user on at least three pages sequentially displayed on the graphical user interface of the mobile communication device.

45. A system as claimed in claim 38, said communication entity being configured for transmitting data to cause the graphical user interface of the mobile communication device to present a first seat selection element allowing the user to select a seat on the departing flight and a second seat selection element allowing the user to select a seat on the returning flight.

46. A system as claimed in claim 38, said communication entity being configured for transmitting data to cause the graphical user interface of the mobile communication device to present a first seat map allowing the user to select a seat on the departing flight with reference to the first seat map and a second seat map allowing the user to select a seat on the returning flight with reference to the second seat map.

47. A system as claimed in claim 38, said communication entity being configured for receiving data conveying passenger information for the departing flight and the returning flight provided by the user via the graphical user interface of the mobile communication device.

48. A system as claimed in claim 38, said communication entity being configured for receiving data conveying an email address provided by the user via the graphical user interface of the mobile communication device and to which a receipt of booking of the departing flight and the returning flight is to be emailed, said processing entity being configured for causing transmission of an email message conveying the receipt of booking the departing flight and the returning flight to the email address.

49. A system as claimed in claim 26, wherein the information regarding the flight pass comprises at least one of: an identifier of the flight pass; an amount of air travel credit remaining in the bank of air travel credit; routes available for booking flights using the flight pass; a name of each of at least one individual eligible to be a passenger on flights booked using the flight pass; an expiry date of the flight pass; and a name of an owner of the flight pass.

50. A system as claimed in claim 26, said communication entity being configured for receiving data conveying authentication information provided by the user via the graphical user interface of the mobile communication device and granting the user access to the flight pass via the graphical user interface of the mobile communication device upon the authentication information having been validated.

51. Computer-readable media containing program code executable by a computing system to implement a process for enabling a user of a mobile communication device to use a flight pass that is associated with a bank of air travel credit applicable to book flights, said program code comprising:
first program code for causing the computing system to transmit data conveying information regarding the flight pass to be presented to the user via a graphical user interface of the mobile communication device;
second program code for causing the computing system to receive data conveying a request to book a flight using the flight pass made by the user via the graphical user interface of the mobile communication device; and
third program code for causing the computing system to cause a booking of the flight using the flight pass.

52. A method for execution by a user of a mobile communication device, said method comprising:
obtaining information regarding a flight pass via a graphical user interface of the mobile communication device; and
making a request to book a flight using the flight pass via the graphical user interface of the mobile communication device.
